(19) United States
(12) Patent Application Publication
(10) Pub. No.: US 2026/0356999 A1
(43) Pub. Date: Nov. 12, 2026

(54) TRANSPARENT SEMICRYSTALLINE COPOLYMER

(71) Applicant: The Regents of the University of California, Oakland, CA (US)

(72) Inventors: Qibing Pei, Calabasas, CA (US); Jiacheng Fan, Los Angeles, CA (US)

(73) Assignee: The Regents of the University of California, Oakland, CA (US)

(21) Appl. No.: 19/662,338

(22) Filed: Apr. 29, 2026

Related U.S. Application Data
(60) Provisional application No. 63/802,742, filed on May 9, 2025.

(51) Int. Cl. C08F 220/18; C08F 220/28; C08K 5/053; C09D 5/29; C09D 7/63; C09D 133/06

(52) U.S. Cl. CPC C08F 220/1818; C08F 220/281; C09D 5/29; C09D 7/63; C09D 133/066; C08F 2800/20; C08F 2810/20; C08F 2810/50; C08K 5/053

(57) ABSTRACT

A composite or film including a continuous phase comprising a polymer; particles comprising a copolymer dispersed within the continuous phase; and wherein the continuous phase and the particles have matching refractive index. A smart window comprising the composite film is also described. The film is transparent (e.g., over 90% average transmittance for electromagnetic radiation having wavelengths in a range of 380 nm to 2500 nm) at the temperature below a threshold temperature (e.g. 40 degrees Celsius) and opaque (e.g., less than average 20% transmittance for the wavelengths in a range of 380 nm to 2500 nm) at the temperature above the threshold temperature (e.g, 45 degrees Celsius).

### CROSS REFERENCE TO RELATED APPLICATIONS

This application claims the benefit under 35 U.S.C. Section 119 (e) of the following co-pending and commonly-assigned application:

U.S. Provisional Patent Application Ser. No. 63/802,742, filed on May 9, 2025, by Qibing Pei and Jiacheng Fan, entitled “TRANSPARENT SEMICRYSTALLINE COPOLYMER,” attorneys' docket number G&C 30494.0511USP2 (UC-2024-267-1); which application is incorporated by reference herein.

### BACKGROUND OF THE INVENTION

### Field of the Invention

The present disclosure relates to transparent polymers, polymers with switchable transmission, and methods of making and using the same.

### Related Art

Windows are essential elements of buildings, yet they contribute to solar heat gain when it is hot and heat loss when it is cold, which lead to significantly increased building energy consumption for heating, ventilation, and air conditioning (HVAC).^{[1]} While thermal insulation techniques such as double and triple-pane glass have been widely deployed, there is a growing interest in optimizing energy efficiency through dynamic control of light transmission across the solar spectrum.^{[2]} These smart windows are designed to incorporate active materials into their fabrication process or to apply additional active layers that respond to external stimuli,^{[3]} such as heat,^{[4]} electrical/magnetic fields,^{[5]} and mechanical stress.^{[6]} Among these, thermally responsive smart windows have gained significant attention due to their passive optical tuning capability, enabling modulation of solar energy without electrical energy input.^{[7]}

Thermally responsive smart windows attain dynamic control of optical transmittance through light scattering. Two broadly investigated materials are polymer-dispersed liquid crystals (PDLCs)^{[8]} and hydrogels,^{[9]} both involving liquid components that lead to low shelf life and potential liquid leakages.^{[10]}

A solid phase-changing polymer (PCP) based smart window is an intriguing alternative due to its simple composition, low cost, long durability, easy installation, and environmental friendliness.^{[11]} We recently introduced a thermoresponsive phase-changing copolymer (TPCC) for smart window applications that achieved a solar light modulation of 62.7% with a phase-transition temperature of 32 °C. However, the visible transmittance of the film at room temperature is limited to 80.9% due to scattering within its semicrystalline polymer domain.^{[12]}

Semicrystalline polymers are generally opaque. Intensive research has been devoted to synthesizing transparent semiconducting polymers. Certain methods have been shown effective to various degrees, such as introducing additional phases to match the refractive index,^{[13]} suppressing crystallization to reduce the number of scattering,^{[14]} and minimizing crystal domain sizes to restrict the scattering sites size.^{[13b, 15]} Restricting the crystal domain size while maintaining the crystallinity has been done via adding nucleation agent to accelerate the nucleation rate, as well as confining the crystal domains via phase separation.^{[16]}. However, thermally responsive smart windows based on phase changing polymers face challenges such as low transmittance at room temperature and limited solar modulation when demanded. What is needed are improved methods of making a smart window material. The present invention satisfies this need.

### SUMMARY OF THE INVENTION

The present disclosure reports on a transparent semicrystalline copolymer composed or comprising of at least a first comonomer whose homopolymer is semicrystalline; and a second comonomer which forms a phase separated mixture with the first comonomer at a low temperature and the mixture turns transparent at an elevated temperature, wherein the copolymer retains no less than 25 percentage of crystallinity relative to the homopolymer of the first comonomer.

The present disclosure further reports on a composite comprising a nanocrystal of the polymer of any of the claims with combined with refractive index-matched submicron-size amorphous polymer particles (μPs) to form optically transparent composite films under ambient conditions.

In one embodiment, a window, or coating for a window, comprises a first phase changing polymer comprising a plurality of nanocrystallites having a maximum dimension or crystal size (as measured from an X-ray diffraction peak by the Scherrer equation) of 100 nm or less below a threshold 35-42 degrees Celsius; and a plurality of particles comprising a second polymer combined with the first polymer, wherein the particles comprise microcrystallites having a maximum dimension or crystal size (as measured from an X-ray diffraction peak by the Scherrer equation) of 50 nm-10 micrometers, and the first polymer and the second polymer have their refractive indices matched (e.g., to within 0.04) below the threshold temperature for transparency of the window but are mismatched above the threshold temperature to tint the window.

In another embodiment, the coating is formed by introducing ethoxylated trimethylolpropane triacrylate to a clear poly (SA) or cross linked copolymer (CPSA) composed of poly(stearyl acrylate) (poly (SA)). High optical transparency and high crystallinity at ambient temperature is achieved by ultraviolet curing at a high temperature to suppress the crystallite domain size to the nm range. Adding poly(hydroxyethyl methacrylate) (poly (HEMA)) in the formula produces a micrometer-size phase-separated terpolymer system where the CPSA phase retains it crystallinity. The two phases can be tuned to have matched refractive index, and the terpolymer film is transparent at ambient temperature with visible transmittance up to 91.4% at 20 °C. Above its transition temperature of 42 to 46 °C, CPSA crystal melting leads to light scattering at phase boundaries. The transmittance modulation is 81.4%, 87.7% and 76.5% for solar (300-2500 nm), visible (380-780 nm), near-infrared (780-2500 nm) spectrum, respectively. Furthermore, a styrofoam chamber installed with the terpolymer smart window can effectively reduce the chamber interior temperature increase by 8.5 °C compared to the reference glass window.

Example embodiments include, but are not limited to, the following.
1: A transparent semicrystalline copolymer, composed or or comprising of at least:
first repeat units polymerized from a first comonomer whose homopolymer is semicrystalline; and
second repeat units polymerized from a second comonomer which forms a phase separated mixture with the first polymer at a low temperature and the mixture turns transparent at an elevated temperature;
and the copolymer retains no less than 25 percentage of crystallinity relative to the homopolymer of the first comonomer.
2: The transparent semicrystalline copolymer of clause 1, wherein the first comonomer is selected from the group consisting of stearyl acrylate, hexadecyl acrylate, tetradecyl acrylate, lauryl acrylate, N-docosyl acrylate, and the second comonomer is ethoxylated trimethylolpropane triacrylate.
3: The transparent semicrystalline copolymer of clause 1 or clause 2, wherein the first and the second co-monomers are copolymerized at an elevated temperature at which the two comonomers form a clear solution.
4. A synthetic polymer comprising the transparent semicrystalline copolymer of any of the clauses 1-3, further comprising a third polymer polymerized from at least a third comonomer which is phase separated from the clear liquid solution of the first and second comonomers at the elevated temperature.
5. The synthetic polymer of clause 4 polymerized from the phase and the clear liquid solution, wherein:
a first additive is dissolved in the phase formed by the third comonomer to adjust its refractive index; and/or
a second additive is dissolved in the clear liquid solution of the first and second comonomers to adjust the refractive index of the clear liquid solution.
6. The synthetic polymer of clause 5 wherein the additive is diethylene glycol.
7. The synthetic polymer of clause 4 or 5 or 6 wherein the third comonomer is hydroxyethyl methacrylate.
8. The synthetic polymer of any of the clauses 4-7, comprising:
a first phase comprising the copolymer comprising poly(stearyl acrylate), poly(hexadecyl acrylate), poly(tetradecyl acrylate), poly(lauryl acrylate), or poly(N-docosyl acrylate) main chains crosslinked with ethoxylated trimethylolpropane triacrylate; and
a second phase comprising poly(hydroxyethyl methacrylate) (poly (HEMA)) phase separated from the first phase,
wherein the poly (SA) is at least 75% by weight of the copolymer and the poly (HEMA) is at least 30% of the synthetic polymer by weight.
9. The synthetic polymer of any of the clauses 4-8, wherein the copolymer further comprises one or more alkyl side chains (N—CₙH₂ₙ₊₁ where n is 12 or larger) connected to a main chain.
10. The synthetic polymer of any of the clauses 4-8 further comprising 5-20% of an additive, for adjusting refractive index, by weight of the second phase.
11. The synthetic polymer of any of the clauses 4-8, wherein the copolymer:
crystallizes to form nanocrystallites each having a maximum dimension less than 100 nm at a temperature below a threshold temperature in a range of 35-42 degrees Celsius, wherein the synthetic polymer is transparent; and
above the threshold temperature, the nanocrytsallites melt by undergoing a glass transition into an amorphous state so that solar electromagnetic radiation, having wavelengths in a range of 300 nm-2500 nm, scatters from phase boundaries between the separated phases ot render the synthetic polymer opaque.
12. A composite, comprising:
a first phase comprising a polymer; and
a second phase phase comprising a copolymer phase separated from the first phase; and
wherein the first phase and the second phase have a matching refractive index below a threshold temperature but not above the threshold temperature.
13. The composite of clause 12, comprising:
the copolymer comprises poly(stearyl acrylate), poly(hexadecyl acrylate), poly(tetradecyl acrylate), poly(lauryl acrylate), or poly(N-docosyl acrylate) main chains crosslinked with ethoxylated trimethylolpropane triacrylate; and
a polymer comprises poly(hydroxyethyl methacrylate) (poly (HEMA)).
14. The composite of clause 12 or 13, wherein:
the second phase comprises particles dispersed in the first phase comprising a continuous phase or matrix or
the first phase comprises microparticles dispersed in the second phase comprising a matrix.
15. The composite of clause 12 or 13 or 14, wherein the copolymer comprises a plurality of nanocrystallites having a maximum dimension or crystal size of 100 nm or less below a threshold temperature 35-42 degrees Celsius, and wherein above the threshold transition temperature the particles are amorphous.
16. The composite of any of the clauses 12-15, wherein the copolymer comprises a polyacrylate with sidechains that crystallize into nanoscale domains below a threshold temperature.
17. A window, or coating or insertion for a window comprising the composite of any of the clauses 1-16.
18. A method of making a composite useful as a coating or insertion for a smart window, comprising:
combining a plurality of monomer precursors with a separate phase and a photoinitiator to form a mixture;
heating the mixture to an elevated temperature above 120 degrees Celsius; and exposing the heated precursor mixture to ultraviolet radiation to initiate polymerization reactions via the photoinitiator, forming a composite comprising a first phase comprising a copolymer and a second phase comprising a polymer phase separated from the first phase; wherein the first phase and the second phase have matching refractive indices below a threshold temperature of 35-42 degrees Celsius but mismatched refractive indices above the threshold temperature.
19. The method of clause 18, wherein the precursors comprise a first comonomer (e.g., SA) and a second comonomer (e.g., crosslinker e.g., ETPTA) and the separate phase comprises a third comonomer (e.g., HEMA), the method further comprising: forming a clear liquid solution of the first comonomer and the second comonomer at the elevated temperature, wherein the third comonomer is phase separated from the clear liquid solution; and wherein the ultraviolet radiation initiates copolymerization of the first comonomer and the second comonomer to form the copolymer and polymerization of the third comonomer to form the polymer, wherein the copolymer is dispersed as particles in the polymer comprising a continuous phase.
20. The method of clause 18 or 19, further comprising: dispersing pre-formed amorphous polymer microparticles having a size of 50 nm to 10 micrometers to form the separate phase in the mixture prior to heating; wherein the monomer precursors comprise a first comonomer (e.g., SA) and a second comonomer (e.g., crosslinker, e.g., ETPTA) that form a clear solution at the elevated temperature; and wherein the ultraviolet radiation initiates copolymerization of the first comonomer and the second comonomer to form a nanophasic crystalline polymer forming a continuous phase with the microparticles dispersed therein.
21. The method of any of the clauses 18-20 used to fabricate the composite of any of the clauses 1-17.

### BRIEF DESCRIPTION OF THE DRAWINGS

The patent or application file contains at least one drawing executed in color. Copies of this patent or patent application publication with color drawing(s) will be provided by the Office upon request and payment of the necessary fee.

Referring now to the drawings in which like reference numbers represent corresponding parts throughout:

FIG. 1A. Cross linked copolymer (CPSA) crystal formation at room temperature, while maintaining high transmittance.

FIG. 1B. Amorphous CPSA at high temperature with transparent appearance.

FIG. 1C. CPSA-HD at room temperature with refractive index matching between CPSA and poly(HEMA)-DEG phases, exhibiting high transparency.

FIG. 1D. CPSA-HD at high temperature with refractive index mismatching between CPSA and poly(HEMA)-DEG phases, rendering opaque appearance.

FIG. 1E. Chemical structures for materials used in CPSA-HD.

FIG. 2A. Transmittance measurement of CPSA with UV processing temperature ranging from 80 C to 165 C. Scanning wavelength is from 300-800 nm.

FIG. 2B. X-ray diffraction (XRD) analysis of CPSA with UV processing temperature at 80, 110, 135, and 165 C.

FIG. 2C. Differential scanning calorimetry (DSC) analysis of CPSA with UV processing temperature at 80, 110, 135, and 165 C.

FIG. 2D. Refractive indices of CPSA (measured and fitted), poly (HEMA), and poly (HEMA) with 15 wt. % DEG, as temperature ranges from 20 to 60 C.

FIG. 2E. Visible transmittance (380-780 nm) of CPSA:HEMA film at ratio 2:1, 1:1, and 1:2 with UV processing temperature at 165 C, under both room temperature (RT, 20 C) and high temperature (HT, 50 C).

FIG. 2F. Visible transmittance of CPSA:HEMA=1:2 with UV processing temperature at 150, 165, and 180 C, under both RT and HT.

FIG. 3A. Variable temperature X-ray diffraction (VT-XRD) analysis of CPSA-HD during heating from 25 to 50 C with heating rate of 10 C min-1.

FIG. 3B. Variable temperature X-ray diffraction (VT-XRD) analysis of CPSA-HD during cooling from 50 to 25 C naturally.

FIG. 3C. Atomic force microscopy (AFM) height image of CPSA-HD sample, inserted scale bar is 1 m.

FIG. 3D. Visible transmittance (380-780 nm) of CPSA-poly (HEMA) with DEG weight ratio ranging from 5-20 wt. %, under both room temperature (RT, 20 C) and high temperature (HT, 50 C). Here CPSA:HEMA ratio controls at 1:2, UV processing temperature is 165 C.

FIG. 3E. Image of CPSA-HD transmittance against a background with “CPSA” patterns according to the temperature increase from 30 to 44 C.

FIG. 4A. Transmittance spectra of CPSA-HD at room temperature (20 C) and high temperature (50 C) across the solar spectrum (300-2500 nm). The inset is the solar irradiance spectrum.

FIG. 4B. Photos of CPSA-HD sample at room temperature and high temperature.

FIG. 4C. Transmittance modulation capability, the solar, visible, and NIR refer to wavelength range of 300-2500 nm, 380-780 nm, and 780-2500 nm, respectively.

FIG. 4D. Performance comparison with recently reported thermochromic smart window regarding the solar modulation and low temperature visible transmittance. The designs include perovskite, hydrogel, VO2, ionic liquid, liquid crystal, and TPCC.

FIG. 4E. Transmittance measurement of CPSA-HD over 1000 heating and cooling cycles at 550 nm, the blue dots are at room temperature (20 C) states, the red dots are at high temperature (50 C) states.

FIG. 4F. Transmittance measurement of CPSA-HD over 1000 heating and cooling cycles at 1100 nm, the blue dots are at room temperature (20 C) states, the red dots are at high temperature (50 C) states.

FIG. 5A. Schematic of the solar blocking experiment set up. (8×6.5×5 inch3) chamber for testing solar gain.

FIG. 5B. Photograph of the solar blocking experiment set up.

FIG. 5C. Temperature profile inside chambers with CPSA-HD and double-glasses reference captured at 13:00, with environmental temperature at 32 C.

FIG. 5D. Temperature profile inside chambers with CPSA-HD and double-glasses reference captured at 15:00, with environmental temperature at 34 C.

FIG. 5E. Temperature profile inside chambers with CPSA-HD and double-glasses reference captured at 17:00, with environmental temperature at 35 C.

FIG. 5F. Temperature differences between chambers with CPSA-HD (sandwiched by double glass) and double-glasses reference determined at 13:00. The experiment was conducted in April in Phoenix, Arizona.

FIG. 5G. Temperature differences between chambers with CPSA-HD (sandwiched by double glass) and double-glasses reference determined at 15:00. The experiment was conducted in April in Phoenix, Arizona.

FIG. 5H. Temperature differences between chambers with CPSA-HD (sandwiched by double glass) and double-glasses reference determined at 17:00. The experiment was conducted in April in Phoenix, Arizona.

FIG. 6A. Atomic force microscopic phase image for CPSA sample with UV curing temperature at 80 °C. The scale bar is 50 nm. An average phase separation size for CPSA sample with UV curing temperature at 80 °C is estimated to be 80 nm.

FIG. 6B. Atomic force microscopic phase image for CPSA sample with UV curing temperature at 110 °C. The scale bar is 50 nm. An average phase separation size for CPSA sample with UV curing temperature at 110 °C is estimated to be 50 nm.

FIG. 6C. Atomic force microscopic phase image for CPSA sample with UV curing temperature at 165 °C. The scale bar is 50 nm. An average phase separation size for CPSA sample with UV curing temperature at 165 °C is estimated to be 15 nm.

FIG. 6D. Atomic force microscopic phase image for pure poly (SA) sample. The scale bar is 50 nm. The pure poly (SA) at this scale does not have distinct phase difference.

FIG. 7A. Transmittance measurement for CPSA for UV curing temperature from 120 to 165 °C, at measurement temperature 20, 35, and 50 °C.

FIG. 7B. Transmittance measurement for CPSA for UV curing temperature from 80 to 110 °C, at measurement temperature 20 °C.

FIG. 8. X-ray diffraction (XRD) pattern for pure Poly (SA).

FIG. 9. Differential scanning calorimetry (DSC) result for pure Poly (SA).

FIG. 10. Table S1 DSC results for poly (SA) and CPSA with different UV processing temperatures.

FIG. 11. Transmittance for CPSA:HEMA ratio at 4:1 at both RT (20 °C) and HT (50 °C.).

FIG. 12. Transmittance for CPSA-poly (HEMA) sample with UV curing temperature at 157.5 and 172.5 °C, under both RT (20 °C) and HT (50 °C). 157.5 °C and 172.5 °C are estimated from the hot plate set up temperature at 250 and 270 °C. The correlation between hot plate set up temperature and actual processing temperature is showing in FIG. 18.

FIG. 13. Variable Temperature X-ray diffraction (VT-XRD) pattern with only background sample stage made of aluminum oxide.

FIG. 14A. AFM Height image with three horizontal cuts for height measurement.

FIG. 14B. The height profile corresponding to the horizontal cutlines.

FIG. 15. Diffusive transmittance measurement for CPSA-HD sample at room temperature (25 °C) and high temperature (50 °C.). The diffusive transmittance was measured using UV Visible/NIR spectrophotometer cooperated with an integrating sphere.

FIG. 16A. Sample temperature heated by the solar radiation with environmental temperature around 35 °C.

FIG. 16B. Two testing chambers temperature profile without the installation of CPSA-HD and glass reference.

FIG. 17. Table 2. Performance comparison with other reported work. Multiplied by 7/6 (SA account for 6/7 weight in CPSA) Estimated value **Critical transition temperature (°C).

FIG. 18. The relationship between the hot plate set up temperature and the actual processing temperature. Specifically, the 120 °C, 140 °C, 160 °C, 180 °C, 200 °C, 220 °C, 240 °C, and 260 °C for hot plate temperature is corresponding to the actual temperature as 80 °C, 85 °C, 95 °C, 110 °C, 120 °C, 135 °C, 150 °C, and 165 °C, respectively.

FIG. 19. Setup for refractive index measuring and homemade thermal water circulation system.

FIG. 20. Modulus-temperature curves of polySA and SA-TA copolymers crosslinked with a long-chain polyurethane diacrylate (UDA).

FIG. 21A. AFM topographic image of a preliminary smart window film based on an HDA-TA-HEA terpolymer.

FIG. 21B. Parallel transmittance at 25 °C and 35 °C of a preliminary smart window film based on an HDA-TA-HEA terpolymer.

FIG. 21C. Light modulation in the solar (300-2500 nm), luminous (390-780 nm, and IR (780-2500 nm) range of a preliminary smart window film based on an HDA-TA-HEA terpolymer.

FIG. 21D. Temperature profiles inside test chambers covered with a doubles-pane glass or terpolymer film as the window.

FIG. 22A. An NCP-P composite film which is normally transparent.

FIG. 22B. An NCP-P composite film which turns opaque to block solar radiation when temperature is above Tm of the NCP.

FIG. 22C. The composite comprises an NCP phase and submicron particles of matching RI.

FIG. 22D. The NCP phase comprises nanocrystallites which melt above Tm.

FIG. 23A-23B. An HDA-TDA-HEA terpolymer film which is normally transparent (FIG. 23A), but scatters light when the temperature is above a certain threshold (FIG. 23B). Note that a film that rejects a significant fraction of incident light would appear white.

FIG. 24A. A crystalline layer in polySA formed via close packing of the octadecyl side chains.

FIG. 24B. Nanophasic SCP comprising high-density nanocrystallites without formation of micro- and macrophases.

FIG. 24C. Melting of the nanocrystallites.

FIGS. 25A-25E. SA-ETPTA copolymer (6:1 weight ratio) cured under UV at elevated temperatures. FIG. 25A. Optical photograph of SA-ETPTA copolymer (6:1 weight ratio) film cured under UV at 85 C. Imaging and measurements were performed at room temperature.

FIG. 25B. Optical photograph of SA-ETPTA copolymer (6:1 weight ratio) film cured under UV at 135 C. Imaging and measurements were performed at room temperature. FIG. 25C. Measured transmittance of SA-ETPTA copolymer (6:1 weight ratio) films cured at specified temperatures. Imaging and measurements were performed at room temperature. FIG. 25D. Wide angle XRD pattern of SA-ETPTA copolymer (6:1 weight ratio) films. Imaging and measurements were performed at room temperature. FIG. 25E. AFM phase image of SA-ETPTA copolymer (6:1 weight ratio) film cured at 135 C. Imaging and measurements were performed at room temperature.

FIG. 26. Scattering efficiency factor q at 550 nm as functions of particle size (d) and refractive index mismatch (Δn) in particle/matrix composites.

FIG. 27. Differential scattering calorimetry curves of representative poly(n-alkyl acrylates). All samples containing a small fraction of a crosslinker.

FIG. 28. Table 3. Experimental and calculated results of phase-changing polymers and molecules.

FIG. 29. Table 4. Endothermal heat capacity of crystal melting determined by DSC (*Multiplied by 7/6).

FIG. 30A. Hydroxyethyl acrylate (HEA), a polar co-monomer to suppress the crystallite size of low-polarity side chains.

FIG. 30B. Hydroxybutyl acrylate, a polar co-monomer to suppress the crystallite size of low-polarity side chains.

FIG. 30C. Polypropylene glycol monoacrylate, a polar co-monomer to suppress the crystallite size of low-polarity side chains.

FIG. 31. Network-forming difunctional co-monomers where the polyermizable groups are methacrylate (MA), acrylate (Ac), and styrene (St). The network chain length, i.e., (a+b), may be varied from 2 to 10.

FIG. 32. Measured reflectance spectra and 3-D FDTD simulated reflectance of phase-separated solid polymer films with specified difference of refractive indices of the two phases: including (a) Experimental measurement and simulation of a terpolymer film (Δn~0.04, 15 Vol % HDA-TDA), (b) Experimental measurement and simulation of a porous PVDF film (Δn~0.42, 50% porosity), (c) Simulation of a terpolymer with 50 Vol % HDA-TDA (Δn=0.066), (d) Simulation of an NCP-μP composite (Δn~0.10, 50 Vol %). All films are 100 μm thick. The simulation assumes a particle size of 800 nm and a constant Δn with wavelength. Reflection by air-film surfaces is subtracted via a reference.

FIG. 33A. Porous PVDF film: dry film in air.

FIG. 33B. Porous PVDF film: impregnated with an index-matching liquid.

FIG. 34. PMMA μPs prepared in house by photoinitiated microemulsion polymerization.

FIGS. 35A-35D. Optical setup with an integrating sphere to measure the parallel transmittance (FIG. 35A), diffuse transmittance (FIG. 35B), total transmittance (FIG. 35C), and reflectance (FIG. 35D).

FIG. 36. Flowchart illustrating a method of making a composition of matter.

### DETAILED DESCRIPTION OF THE INVENTION

In the following description of the preferred embodiment, reference is made to the accompanying drawings which form a part hereof, and in which is shown by way of illustration a specific embodiment in which the invention may be practiced. It is to be understood that other embodiments may be utilized and structural changes may be made without departing from the scope of the present invention.

### Technical Description

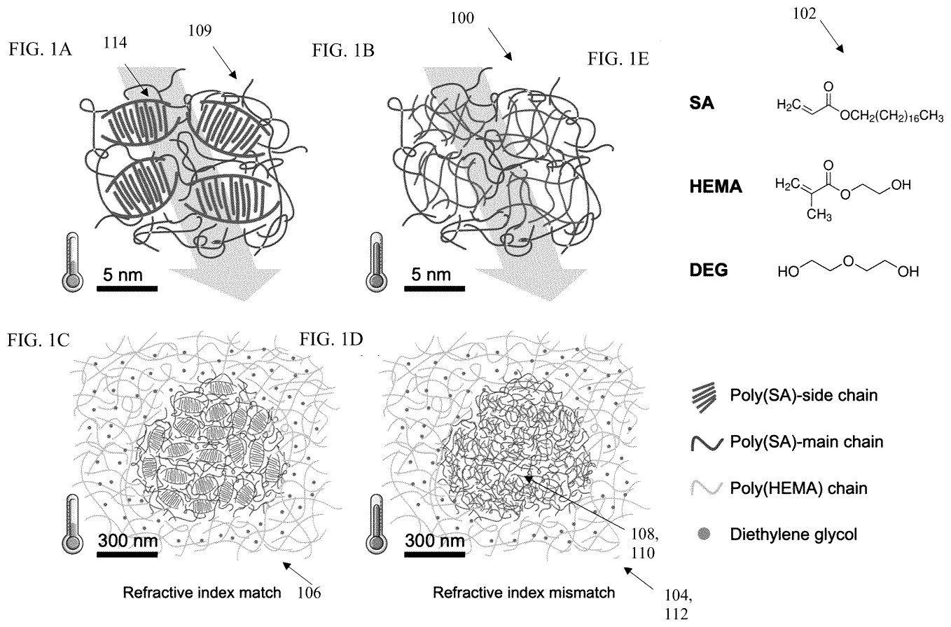

FIG. 1 illustrates a transparent semicrystalline copolymer 100 composed or comprising repeat units polymerized from at least a first comonomer 102 whose homopolymer is semicrystalline; and repeat units comprising a second comonomer which forms a phase separated mixture with the first comonomer at a low temperature and wherein the mixture turns transparent at an elevated temperature, wherein the copolymer retains no less than 25 percentage of crystallinity relative to the homopolymer of the first comonomer.

FIG. 1 further illustrates a composite 104 comprising a first phase 106 comprising a polymer; and a second phase 108 comprising a copolymer 109 phase separated from the first phase. The first phase and the second phase have a matching refractive index (e.g., within 0.01) below a threshold temperature (e.g., in a range 32-45 degrees Celsius) but are different by at least 0.02 above the threshold temperature. In this example, the second phase comprises particles 110 dispersed in the first phase comprising a continuous phase or matrix 112.

FIG. 1 further illustrates the copolymer 109 comprises a plurality of nanocrystallites 114 (e.g., having a maximum dimension or crystal size, e.g., as measured from an X-ray diffraction peak by the Scherrer equation, of 100 nanometers or less) below a threshold temperature 35-42 degrees Celsius, and wherein above the threshold transition temperature the particles are amorphous.

In this example, the copolymer comprises polySA backbones crosslinked with ETPTA and having SA sidechains. The copolymer is dispersed in polyHEMA continuous phase.

### First Example Composite and Polymer

A novel approach to obtain high crystallinity and high transparency is illustrated via poly(stearyl acrylate) (poly (SA)) where each monomer unit contained a crystalline long alkyl chain. The polymer was prepared by UV curing at elevated temperatures, and further crosslinked with a trifunctional co-monomer, ethoxylated trimethylolpropane triacrylate (ETPTA) at a high concentration to constrain the size of the crystallites without substantially lowering the percent crystallinity. The crosslinked copolymer was transparent at both room temperature (20 °C) and elevated temperatures above the crystallite melting (FIG. 1A, 1B). A hydrophilic ter-monomer, hydroxyethyl methyl methacrylate (HEMA), was added into the polymer formula to induce phase separation, creating micrometer-sized light scattering sites for optical transmittance modulation. The refractive index of the ter-monomer was further matched with poly (SA) at room temperature by introducing a low index diethylene glycol (DEG). The resulting CPSA-poly (HEMA)-DEG or CPSA-HD, exhibited a high visible transmittance at 20 °C (FIG. 1c), with the ability to transition to a strongly scattered state across the solar spectrum at elevated temperatures due to refractive index mismatch (FIG. 1d). This film showed promise to mitigate solar heat gain in hot weather.

### Results for the First Example Polymer and Composite

See also A Transparent Semicrystalline Polymer Used in Thermally Responsive Smart Window Application” by Jiacheng Fan, Thomas Wakuta, HyeonJi Hong, Ying Liu, Yu-Ching Chen, Rongke Xu, Yuxuan Guo, Jianghan Wu, Isabelle Winardi, Ting-Hsuan Wu, Zhixin Xie, Yuan Meng, Qibing Pei, https://doi.org/10.1002/adfm.202506061 Adv. Funct. Mater.35, no. 48 (2025): 2506061, and supporting information

### 2.1. CPSA as a Transparent Semicrystalline Polymer

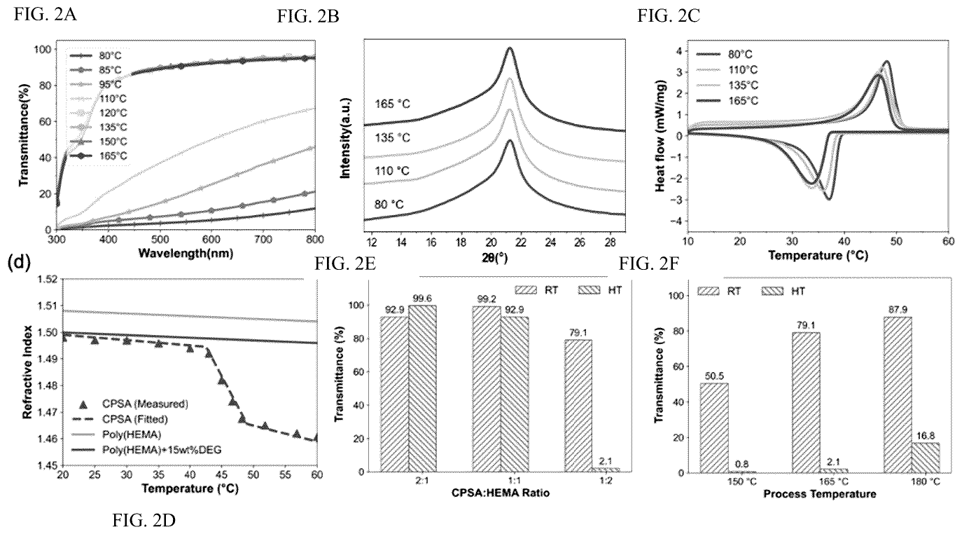

Poly (SA) homopolymer is semicrystalline and opaque at room temperature. By combining SA with ETPTA at a weight ratio of 6:1, a copolymer was obtained. The optical transmittance of the copolymer films was dependent of the temperature at which the co-monomers were cured under UV exposure (FIG. 2a). Due to incompatibility of SA with ETPTA, copolymer films cured below 80 °C was nonuniform. At 80 °C curing, the resulting film was highly opaque with an average transmittance of around 5.8% across the spectrum from 380 to 780 nm. As the UV curing temperature was increased to 110 °C, a highly diffusive film was obtained with 43.9% transmittance at 550 nm. By further increasing the processing temperature to 120 °C and above, the CPSA film yielded a high transmittance of 91.7% at 550 nm with an average transmittance of 91.2% across the spectrum from 380 to 780 nm.

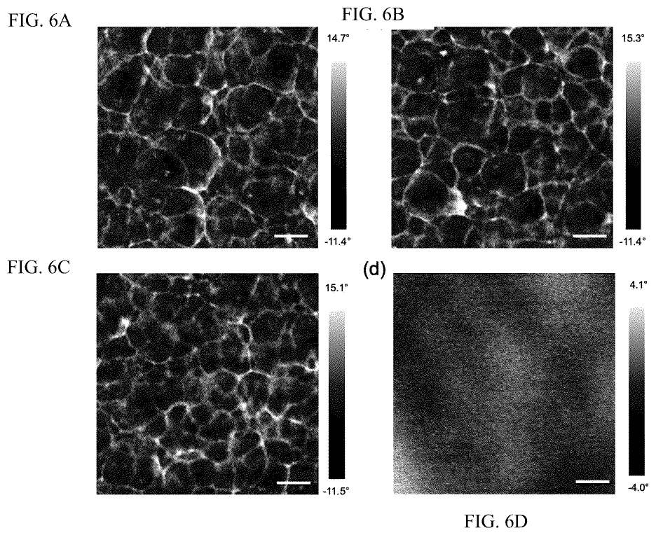

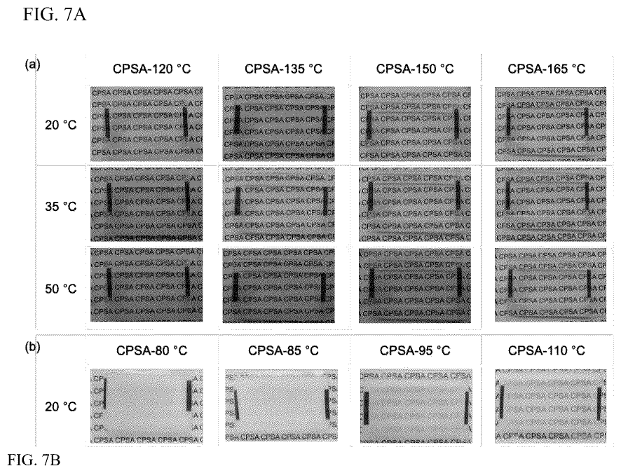

The improvement in transmittance with increasing UV curing temperature could be further explained by the atomic force microscopy (AFM) phase imaging (FIG. 6). With UV curing temperature rising from 80 to 165 °C, the phase separation size between poly (SA) and ETPTA decreased from 80 to 20 nm, rendering a transparent copolymer film due to the decreasing in the size of the light scattering sites. FIG. 7 showed that all the films prepared between 120 to 165 °C exhibited high transparency in the measurement temperature range between 20 to 50 °C, and films prepared between 80 to 110 °C presented lower transparency in the measurement temperature at 20 °C.

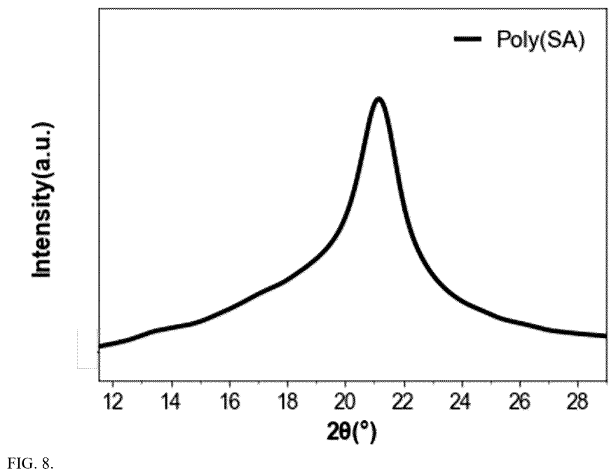

Wide-angle X-ray diffraction (XRD) analysis was performed on the CPSA films prepared at different UV curing temperatures (FIG. 2b). The characteristic diffraction peak at 2θ~21.2° corresponded to poly (SA) crystals (FIG. 8). The peak position and full width at half maximum (FWHM) remained more or less unchanged with the curing temperatures between 80 to 165 °C. The crystal sizes estimated based on the Scherrer equation (Equation 1) were ranging between 3.2 to 4.0 nm.

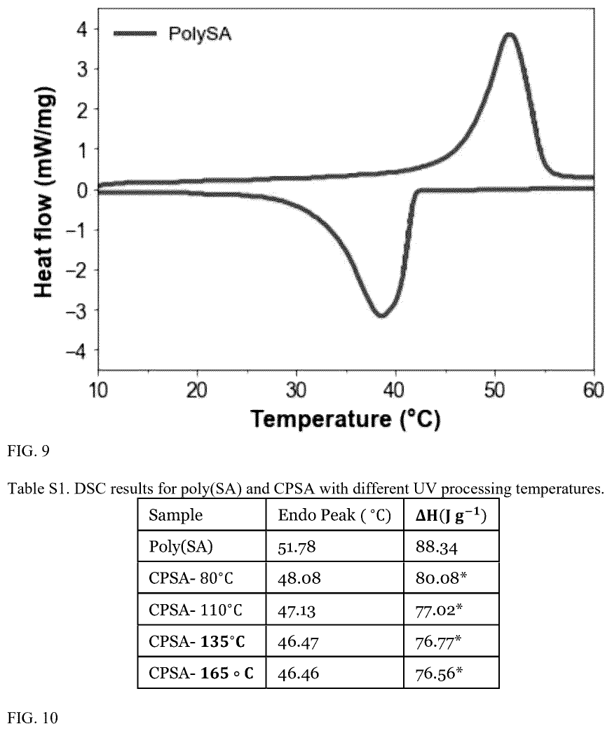

Differential scanning calorimeter (DSC) analysis was conducted to evaluate the relative percentage of crystallinity of the CPSA (FIG. 2c). The heat flow value for CPSA was multiplied by a factor of 7/6, corresponding to the weight ratio of SA in CPSA, for direct comparison with the thermal properties of poly (SA) homopolymer (FIG. 9). The endo melting peak of poly (SA) was measured at 51.8 °C. The melting point of CPSA was slightly decreased from 48.2 to 46.5 °C as the curing temperature was increased from 80 to 165 °C, which might indicate a slight reduction of the crystallite size. The specific phase transition enthalpy (ΔH) was determined by integrating the melting heat flow peak. As shown in Table S1 in FIG. 10, the ΔH values for CPSA films cured at 80, 110, 135, and 165 °C were 80.1, 77.0, 76.8, and 76.6 J g⁻¹, respectively. It decreased gradually with higher curing temperature. However, even the sample cured at 165 °C had a phase change enthalpy value that was 86.7% as compared to the non-crosslinked homopolymer. By comparing the enthalpy values, the relative percentage of crystallinity could be estimated to be 90.7%, 87.2%, 86.9%, and 86.7%, relative to poly (SA), for the samples cured at 80, 110, 135, and 165 °C, respectively. These results were consistent with the previous XRD analysis, indicating that the transparent CPSA maintained a high level of crystallinity.

### 2.2. CPSA-Poly (HEMA) Analysis

The synthesis of the phase-separated terpolymer system followed a similar procedure as the CPSA. The HEMA was cured together with CPSA to create phase separation. Refractive index measurements were conducted on CPSA and poly(HEMA) samples to examine index matching and mismatching while increasing the temperature from 20 to 60 °C (FIG. 2d). The refractive index of poly (HEMA) exhibited a gradual decline from 1.508 at 20 °C to 1.504 at 60 °C, attributed to thermal expansion. There was no phase change in this temperature range. The refractive index of CPSA slightly decreased from 1.499 at 20 °C to 1.495 at 42 °C. Between 42 and 48 °C, the refractive index of CPSA experienced a sharp decline from 1.495 to 1.469, due to the melting of poly (SA) nanocrystallites. Subsequently, the refractive index further decreased to 1.459 at 60 °C. The index contrast between poly (HEMA) and CPSA at 20 °C was measured to be 0.009, indicating a substantial difference that could introduce light scattering between CPSA and poly(HEMA) phases. The resulting terpolymer film was translucent.

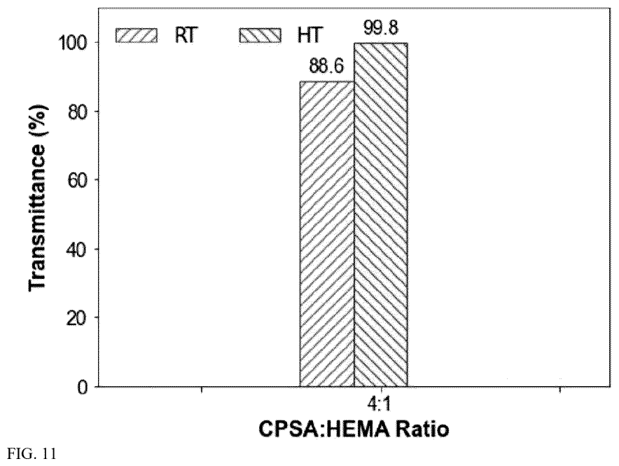

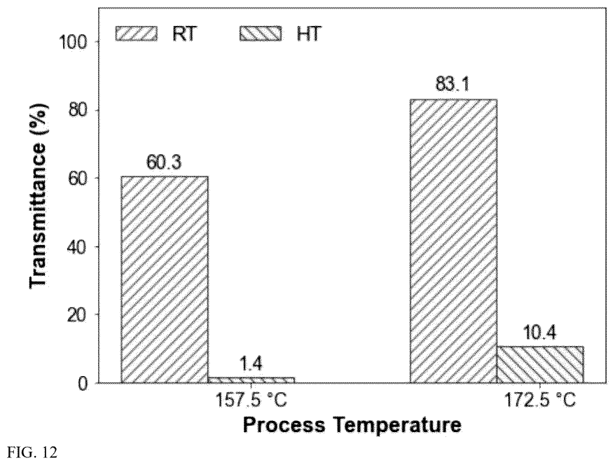

The visible transmittance of the CPSA-poly (HEMA) film in the visible spectrum (380 nm to 780 nm) was calculated (Equation 2), and the results were shown in FIG. 2e and FIG. 11 for CPSA:HEMA ratios of 2:1, 1:1, and 1:2, at room temperature (RT, 20 °C) and high temperatures (HT, 50 °C). Ratios less than 1:2 resulted in non-uniform films. At CPSA:HEMA ratio of 2:1, the CPSA-poly (HEMA) terpolymer film had a transmittance of 92.9% at RT and 99.6% at HT, indicative of negative modulation (Equation 3). When the CPSA:HEMA ratio reached 1:1, the sample showed a small modulation capability of 6.3%, with a transmittance of 99.2% at RT and 92.9% at HT. These results suggested that for CPSA:HEMA film samples with ratios of 2:1 and 1:1, micrometer sized phase separations were not formed for light scattering across the visible spectrum. At the ratio of 1:2, i.e. the terpolymer comprised one third by weight of CPSA and two thirds of poly (HEMA), the transmittance is 79.1% at RT and 2.1% at HT, for a high optical modulation of 77.0%. The 79.1% transmittance at RT made the film translucent and could be attributed to the refractive index mismatch between CPSA and poly(HEMA) moieties (Δn=0.009). The 2.1% transmittance at HT was driven by the increased refractive index mismatch between CPSA and poly (HEMA) (Δn=0.040).

While fixing the CPSA:HEMA at 1:2, the UV curing temperature was varying between 150 and 180 °C. The visible transmittance data showed higher transmittance for both RT and HT with increasing processing temperature (FIG. 2f, FIG. 12). The transmittance modulation was determined as 49.7%, 77.0%, and 71.1% for processing temperatures of 150, 165, and 180 °C, respectively, while the modulation peak was shown as the processing temperature at 165 °C.

### 2.3. CPSA-Poly (HEMA)-DEG Analysis

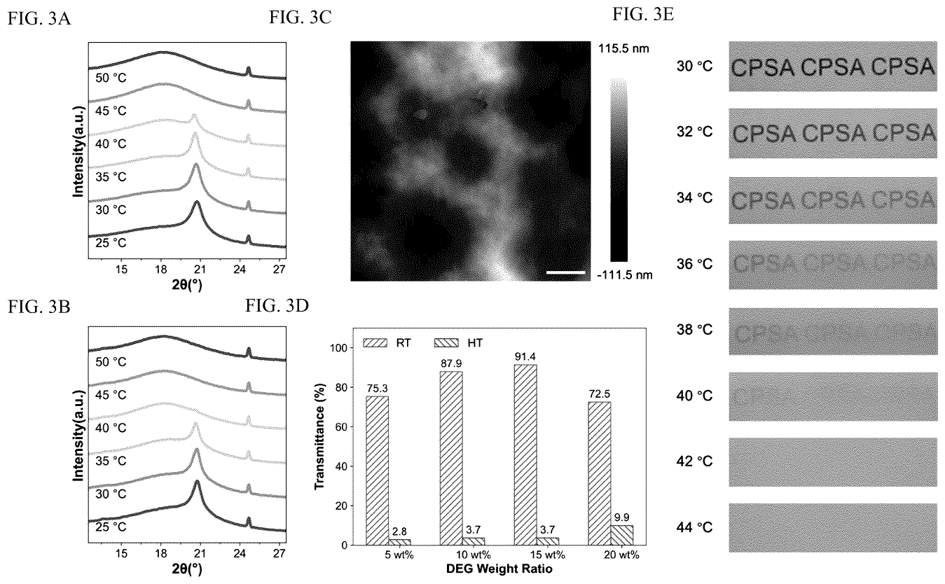

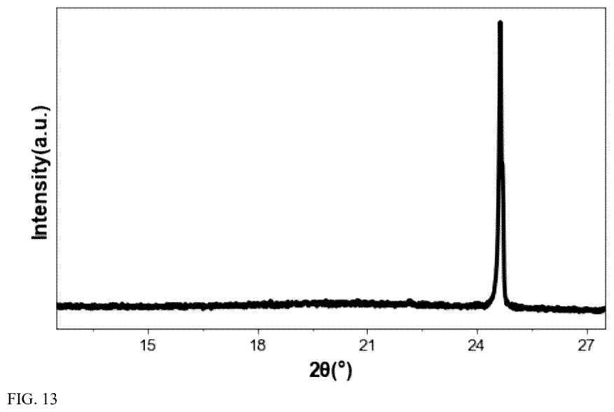

To overcome the small but finite Δn=0.009 between CPSA and poly(HEMA) at RT, diethylene glycol (DEG) was added into the poly (HEMA) phase to lower its refractive index. The weight ratio of SA:ETPTA:HEMA was kept at 6:1:12, DEG was added into the formula at 5 to 20 wt. % relative to the HEMA weight. The similarity in hydrophilicity with HEMA and its high boiling point (244 °C) afforded uniform distribution of DEG in the poly (HEMA) phase in the resulting terpolymer. The refractive index of DEG, reported as 1.4472, could effectively lower the index of poly (HEMA). Refractive index measurements (FIG. 2d) revealed that the poly (HEMA) film with 15 wt. % DEG had a refractive index of 1.499 at 20 °C which aligned well with the CPSA phases at RT. The refractive index became 1.497 at 50 °C which was much higher than that of CPSA (Δn=0.032) at the same temperature. When polymerizing the ter-monomers into CPSA-poly (HEMA)-DEG, or CPSA-HD, the reversible refractive index switching resulting from the poly (SA) crystalline-amorphous transition was studied using variable temperature X-ray diffraction (VT-XRD). VT-XRD was performed during heating and cooling cycles between 25 to 50 °C to observe the phase transition (FIG. 3a, b). At 25 °C, the CPSA-HD exhibited a distinct diffraction peak, specifically a (100) diffraction peak 2θ ~20.9°, indicating good crystallinity. The ordered packing of the crystalline structure was maintained until 40 °C with a heating rate of 5 °C min⁻¹. Heating caused the CPSA-HD crystal to melt, as indicated by the presence of a broader peak around ~18.1°. As the sample was heated to 45 °C, the crystal characteristic peak completely disappeared, leaving behind a single broad band. The peak position was further shifted by 0.1 to a smaller angle during heating, suggesting the induction of a smaller amorphous feature. Upon cooling from 50 to 25 °C, the recrystallization process was observed. Crystallization of CPSA-HD initiated around 40 °C, along with the appearance of the crystal characteristic peak. Upon cooling back between 30 to 35 °C, the peak at position 2θ ~20.9° was reestablished, indicating the completion of the recrystallization process. The crystallinity of CPSA-HD at 25 °C remained unchanged after one cycle of heating and cooling, demonstrating its reversible phase change capability. Notably, the peak at position 2θ~24.3° was from the background sample stage made of aluminum oxide (FIG. 13).

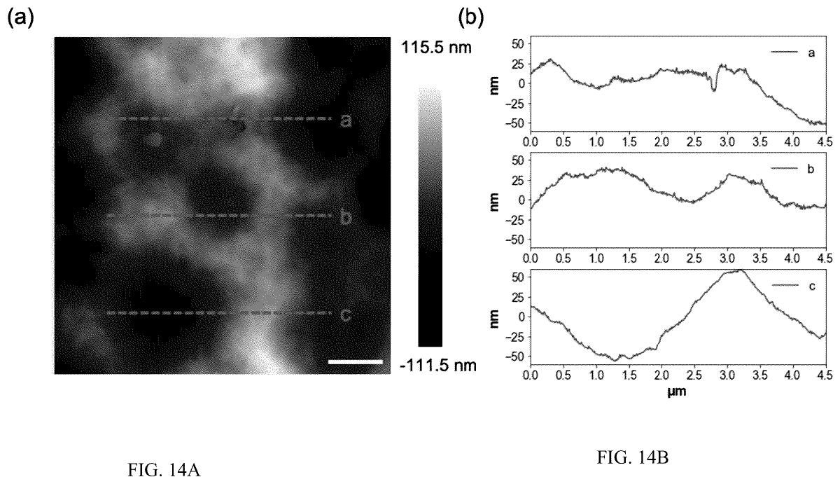

Atomic Force Microscopy (AFM) was utilized to further study the phase separation in CPSA-poly (HEMA)-DEG samples, referred to as CPSA-HD. The height image was provided based on the surface morphology of CPSA-HD (FIG. 3c, FIG. 14). Features ranging in size from 800 nm to 3 μm were observed, comprising approximately 30% of the total volume. These features corresponded to the CPSA distribution within the continuous poly (HEMA)-DEG phases, serving as scattering sites and ensuring extensive light scattering across the solar spectrum.

Such reversible switching in refractive index with varying temperature, as well as the formation of the phase separation as scattering sites, allowed of effective transmittance modulation of the CPSA-HD sample. Transmittance of the resulting CPSA-poly (HEMA) with varying amounts of DEG was shown in FIG. 3d. The highest transmittance of 91.4% at RT was achieved at 15 wt. % DEG due to best index matching, while a low transmittance of 3.7% at HT was obtained due to the index mismatching. To visualize the CPSA-HD transmittance change under different temperatures, we recorded three heating-cooling cycles ranging between 25 to 60 °C (FIG. 3e). For each cycle, the heating was completed within 5 minutes and cooling down naturally to room temperature took 10 minutes. The “CPSA” patterns printed on the background paper were clearly visible at 36 °C, while the light scattering intensity increased from 36 to 42 °C when “CPSA” patterns are completely obscured.

### 2.4. Characterization of Transmittance Modulation of CPSA-HD

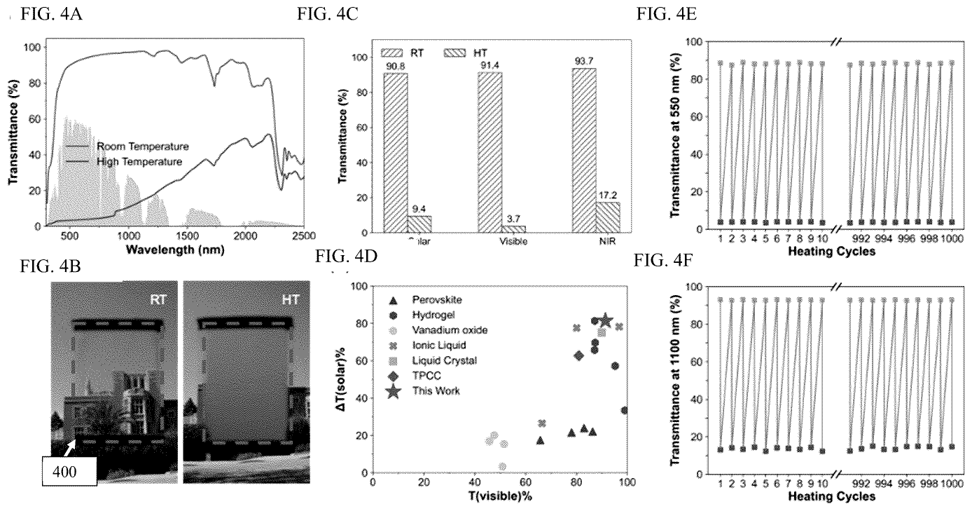

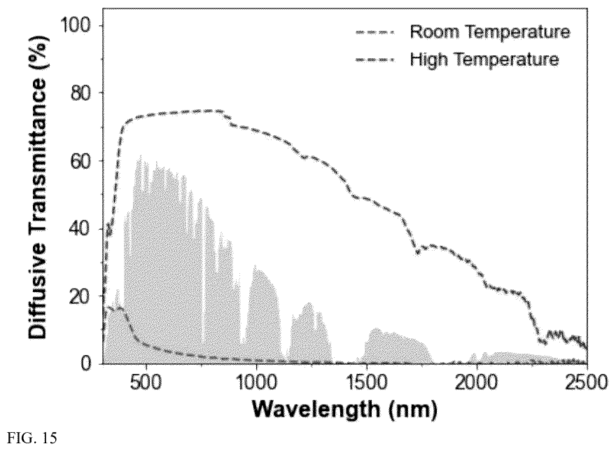

The transmittance measurement of CPSA-HD was characterized across the entire solar spectrum (300 to 2500 nm), as depicted in FIG. 4a and FIG. 15. At RT, CPSA-HD exhibited high transparency across the spectrum, while at elevated temperatures, the transmittance data indicated suppression to a low level, signifying a strong light modulation capability.

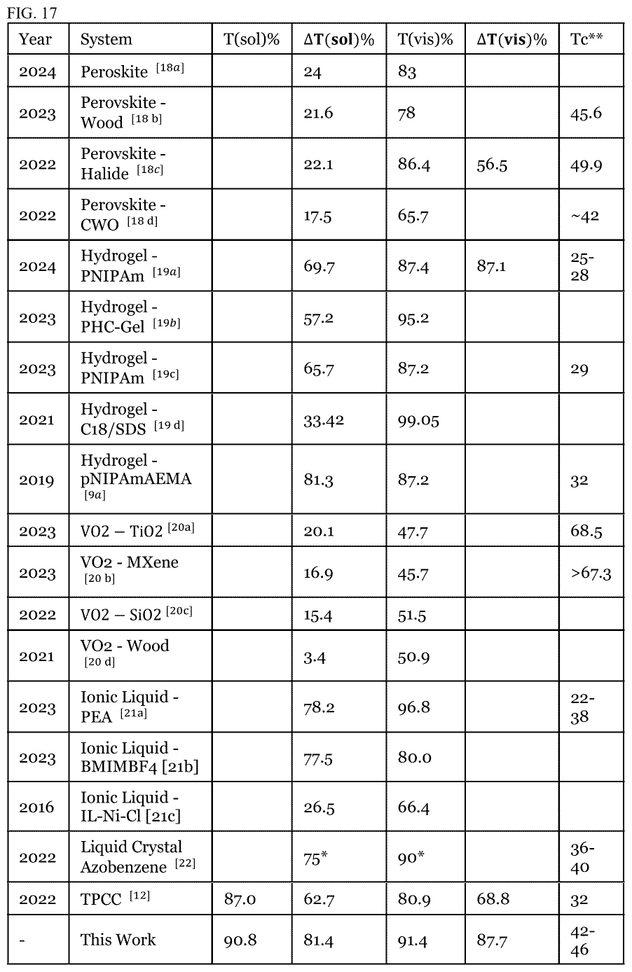

The optical photograph in FIG. 4b showed CPSA-HD's complete transparency at RT, with no observed light scattering or haziness. Background structures such as buildings and trees remained clear and undisturbed. However, at elevated temperatures, CPSA-HD demonstrated intense light scattering, appearing white and hazy. Background structures became completely obscured, indicating a strong light-blocking capability. The transmittance value at RT were determined to be 90.8%, 91.4%, and 93.7% for solar (Tₛₒₗₐᵣ, 300-2500 nm), visible (Tᵥᵢₛ, 380-780 nm), and near infrared (T_{NIR}, 780-2500 nm), respectively (FIG. 4c). Increasing the temperature to 50 °C turned the CPSA-HD opaque due to large refractive index mismatch between two separated phases, with the measured values of Tₛₒₗₐᵣ, Tᵥᵢₛ and T_{NIR} dropping sharply to 9.4%, 3.7% and 17.2%, respectively. The transmittance modulation ΔTₛₒₗₐᵣ, ΔTᵥᵢₛ, and ΔT_{NIR} was 81.4%, 87.7% and 76.5%, respectively. FIG. 4d and Table S2 in FIG. 17 compared the figure-of-merit ΔTₛₒₗₐᵣ and visual transmittance of the CPSA-HD with published thermochromic smart window designs based on different technologies, including perovskite,^{[18]} hydrogel,^{[9a, 19]} VO₂,^{[20]} ionic liquid,^{[21]} liquid crystal,^{[22]} and TPCC.^{[12]}

To examine the reversibility and durability of the transmittance modulation, CPSA-HD films were subjected to 1000 heating-cooling cycles between 20 and 50 °C. FIG. 4e displayed the transmittance at 550 nm of the films in the first ten cycles and the last ten cycles. Overall, the transmittance remained unchanged at both the transparent and opaque state, and the transmittance modulation remained constant over 1000 cycles. FIG. 4f showed the results at 1100 nm.

### 2.5. Solar Energy Blocking Experiment

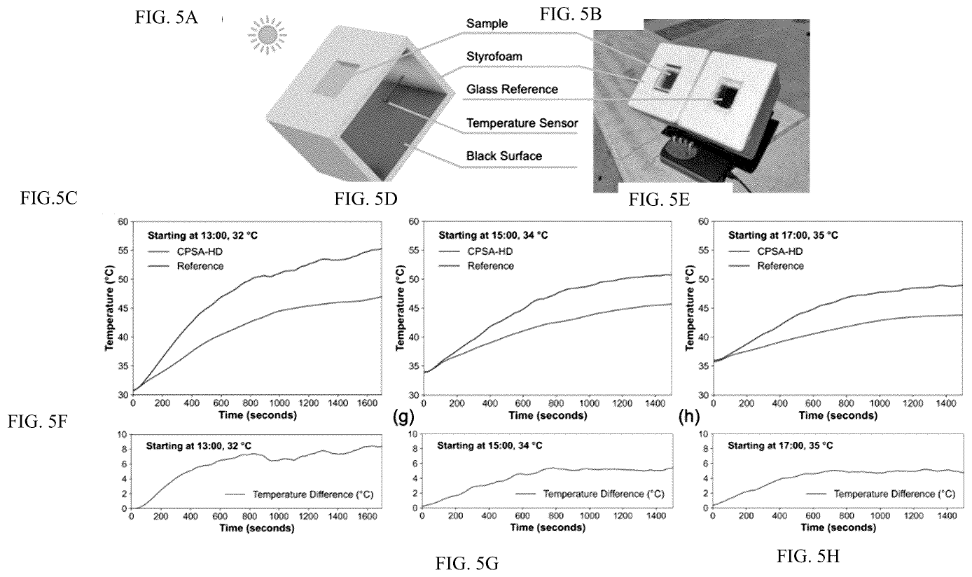

The capability of the CPSA-HD films to block solar radiation for energy saving purposes was measured. The experimental setup was illustrated in FIG. 5a, b, involving two identical styrofoam chambers except the opening at the top, one being covered by the CPSA-HD sandwiched by double glass and the other chamber opening covered by a double-glasses reference. Inside the chamber, a black vinyl tape was used to serve as the thermal absorption layer to capture the radiation transmitted through the window. Temperature changes inside the chamber were monitored using Pico TC-08 thermocouples at a sampling rate of one point per second.

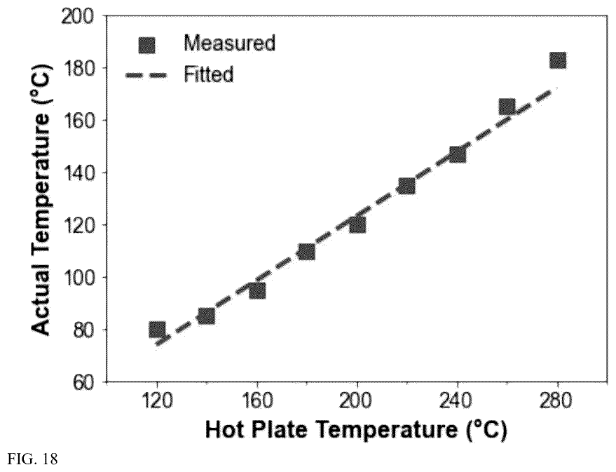

The experiment was performed on a sunny day in Phoenix, Arizona, with ambient temperatures ranging between 32-35 °C. Three tests were conducted at 13:00, 15:00, and 17:00, respectively (FIG. 5c-g). Due to direct solar radiation, both CPSA-HD sample and the double-glass references were heated ~10 °C higher than the ambient temperature, causing the CPSA-HD sample to undergo the phase change and become opaque before installing to capture the chamber interior temperature change (FIG. 18a).^{[23]} At 13:00, when the solar radiation was the strongest, the temperature inside the chamber with the double-glass reference increased to around 55.62 °C in 30 minutes, while the chamber with CPSA-HD sample experienced a slower temperature rise, reaching equilibrium at 47.12 °C. A temperature difference of 8.50 °C was observed compared to the chamber with the double-glass reference. Similar results were obtained at 15:00 and 17:00, with temperature differences between CPSA-HD and double-glass reference being recorded as 5.67 and 5.27 °C, respectively. These findings indicated CPSA-HD's strong optical modulation capability in reducing the solar gain. FIG. S10b illustrated the temperature measurement for testing chambers when tops were open, without CPSA-HD or glass reference being installed. Both chambers, exposed to the same solar radiation, showed similar temperature profiles, confirming that the observed heat gain and temperature increase were solely attributed to the presence of the installed CPSA-HD sample and the reference double-glass. These solar test results provided convincing evidence for the efficacy of CPSA-HD as an optically switchable material in smart window applications, facilitating energy-saving purposes.

The present disclosure shows that a transparent semicrystalline polymer, CPSA, can achieve high transmittance for a smart window at room temperature. CPSA was fabricated by UV curing at temperature over 120 °C. The crystallinity of CPSA remained consistent with pure poly (SA). Introducing a hydrophilic HEMA monomer created a phase separation in CPSA, while the addition of a high boiling point DEG matched the refractive index between CPSA and poly(HEMA) at the low temperatures. Above the melting temperature, the poly (SA) crystals underwent a crystalline to amorphous phase transition, resulting in a drop in a refractive index. The mismatching in refractive index between CPSA and poly(HEMA)-DEG, coupled with the large phase separation due to hydrophilicity differences, led to a strong light scattering across the solar spectrum, enabling transmittance modulation. CPSA-HD demonstrated a transmittance of 91.4% at 20 °C and drops to 3.7% at 50 °C, exhibiting a high transmittance modulation (ΔTₛₒₗₐᵣ, ΔTᵥᵢₛ, and ΔT_{NIR} of 81.4%, 87.7% and 76.5%, respectively), with proven durability over 1000 heating and cooling cycles.

Additionally, solar blocking experiments confirmed CPSA-HD's ability to modulate incoming solar radiation, significantly reducing the solar heat gain. With its superior performance in low temperature transmittance and solar modulation capability, CPSA-HD showed a great potential for smart window applications.

### 3. Experimental Methods Used to Manufacture the Polymer and Obtain the Results Described Herein

### 3.1. Materials

Stearyl acrylate (SA, 200 ppm monomethyl ether hydroquinone as inhibitor, 97%), 2-Hydroxyethyl methacrylate (HEMA, contains≤50 ppm monomethyl ether hydroquinone as inhibitor, 99%), Diethylene glycol (DEG, 99%), 2,2-dimethoxy-2-phenylacetophenone (DMPA, 99%) were purchased from Sigma-Aldrich. Ethoxylated trimethylolpropane triacrylate (ETPTA) was supplied from Sartomer. All of the chemicals were used as received without further purification.

### 3.2. Fabrication Process

2-Hydroxyethyl methacrylate (HEMA), stearyl acrylate (SA), ethoxylated trimethylolpropane triacrylate (ETPTA) and Diethylene glycol (DEG) were mixed at 2.4 g, 1.2 g, 0.2 g and 0.36 g, respectively, with ratio of HEMA:SA:ETPTA:DEG=12:6:1:1.8. 0.036 g (1 wt. %) of 2,2-dimethoxy-2-phenylacetophenone (DMPA) was added as photo-initiator for UV curing. The entire mixture was vigorously stirred in a silicon oil bath at 120 °C, with stirring speed 500 rpm for 10 min. The mixture shifted from phase separated dispersion to a clear solution after the stirring. A metal plate was placed onto a hot plate in order to get uniform heating. The hot plate was set to 260 °C, with actual processing temperature at 165 °C. A double glass sandwich was prepared with a 340 μm thick polyimide spacer. The entire glass sandwich was placed on to the metal plate to reach thermal equilibrium for 10 min. The resulting polymer film was fabricated by injecting the clear solution between two glass slides. Without taking the sample out from the hotplate, a handheld 100 W UV light was directly shine on top of the sample for curing. The UV curing process took 5 min.

To study the optical performance of CPSA-HD and CPSA with different processing temperature for UV curing, the hot plate setup temperature was varying from 240 to 280 °C (actual temperature was measured from 150 to 180 °C) and 120 to 260 °C (actual temperature was measured from 80 to 165 °C), respectively. The hot plate setup temperature had a correlation with the actual processing temperature as shown in FIG. 18. To study the HEMA and SA ratio that could lead to different modulation capabilities, a composition of SA:HEMA ratio ranging from 4:1, 2:1, 1:1, and 1:2 was fabricated. To study the different amount of DEG, a series of 5, 10, 15, and 20 wt. % according to HEMA monomer weight were added. In this discussion, the CPSA formula in this paper referred to the monomer composition SA:ETPTA=6:1, poly (HEMA)-DEG was referring to 15 wt. % DEG added regarding the weight of HEMA.

### 3.3. Characterization Methods

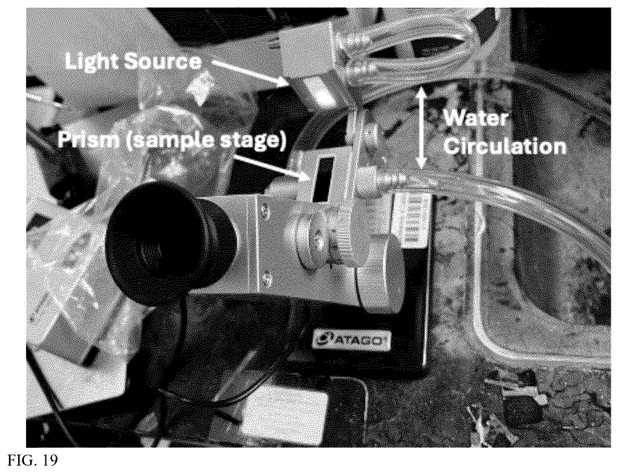

Transition temperature and thermal behavior were characterized by a PerkinElmer differential scanning calorimeter (DSC 8000) under nitrogen atmosphere from 0 °C to 100 °C with a heating and cooling rate of 15 °C min⁻¹. Refractive indexes were obtained using an Abbe refractometer NAR-IT Solid under the D-line wavelength (589 nm), connected with a homemade water circulation system (FIG. 19). The video recording of the CPSA-HD sample at heating and cooling cycles were taken when the film was placed on an ITO/Glass heating pad (H401-GLASS-90) with a thermal controller (H401-T-PENNY), the heating temperature information was captured and recorded by an infrared camera (ICI 9320P). The handheld UV lamp for UV curing was a UVP Blak-Ray B 100AP High Intensity UV Inspection Lamp. Atomic force microscopy (AFM, Bruker Dimension-FastScan) was operated in the tapping mode, using RTESPA-75 and RTESPA-150 silicon probes. The height profiles and phase images were obtained and analyzed using the software NanoScope Analysis 1.7.

Variable Temperature X-ray Diffraction (VT-XRD) analysis was measured from 25 to 50 °C at a heating rate of 10 °C min⁻¹, cooling process was natural cool down. The equipment was a Panalytical X'Pert Pro Powder Diffractometer with Cu Kα (1.5418 Å) radiation with a high temperature chamber (HTK 1200, Anton Paar). The average crystal size from XRD peak was calculated by the Scherrer equation:

$$D = \frac{0.94 \times λ}{β \times cos \times θ} \qquad ( 1 )$$

Where D is the average crystal size, λ is X-ray wavelength, β is the line broadening at half of the maximum intensity (FWHM) in radians, θ is the Bragg angle in radians.

Transmittance spectrum of the samples was measured using an UV-Visible/NIR spectrophotometer (V-770 with 60 mm φ integrating sphere ISN-923). The optical modulation capability was characterized by integration of the transmittance spectrum with solar spectrum in solar, visible, and infrared wavelength regimes. Tₛₒₗₐᵣ (300-2500 nm), Tᵥᵢₛ (380-780 nm), and T_{NIR} (780-2500 nm) and modulations across different spectrum were calculated as follow equations:

$${T}_{solar} , {T}_{vis} , {T}_{NIR} = \frac{\int ϕ ( λ ) T ( λ ) d λ}{\int ϕ ( λ ) d λ} \qquad ( 2 )$$

ΔTₛₒₗₐᵣ,ΔTᵥᵢₛ,ΔT_{NIR}=Tₛₒₗₐᵣ,Tᵥᵢₛ,T_{NIR}(cool state)−Tₛₒₗₐᵣ,Tᵥᵢₛ,T_{NIR}(hot state) (3)

T (λ) represents the recorded transmittance spectrum at a particular wavelength. For T_{solar/NIR}, φ(λ) is the solar irradiance spectrum for air mass 1.5. For Tᵥᵢₛ, φ(λ) is the CIE “physiologically relevant” luminous efficiency function.

The solar energy blocking experiment was conducted on a styrofoam chamber with dimension of 8×6.5×5 inch³. Double reference glass and CPSA-HD sample sandwiched by double glasses were assembled on top of the chamber box with opening size of 2×3 inch². A Pico TC-08 USB thermocouple Data Logger was used for temperature measurement, and PicoLog Data Logging Software was used for temperature data collection. The sampling rate was one point per second.

### 4. Further Example Polymers Including NCP-Microparticle Composites

As discussed herein, solid state polymers are usually either amorphous which are transparent, or semicrystalline which are opaque but become amorphous and transparent above their crystalline melting temperature. The refractive index of the crystalline domain is higher than the amorphous domain, resulting in an inhomogeneous distribution of optical refractive index (RI) across the semicrystalline polymers, which causes light scattering. A high degree of crystallinity (X_{c}) usually intensifies both Mie and Rayleigh scattering due to formation of large spherulites and increased density fluctuations.^{14, 15}

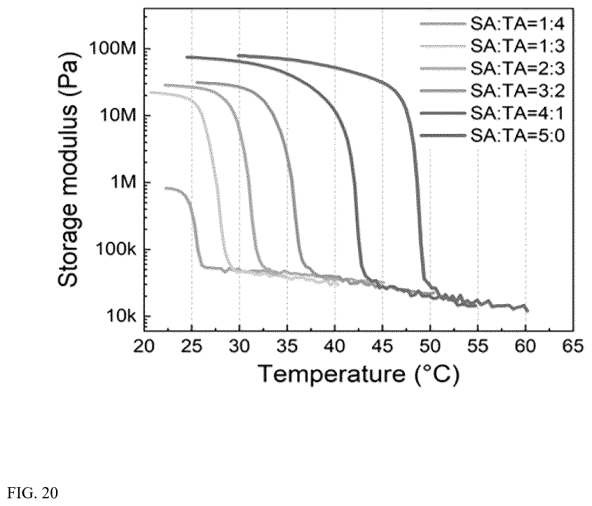

Semicrystalline polymers' phase-change moieties can either be on the polymer main chain or on side groups. Main-chain crystallizable polymers (MCP) are believed to form chain-folded lamellar structures ~10 nm thickness. A long polymer chain is folded multiple times and entangles with other chains, resulting in supercooling and a wide span of crystallization and melting temperatures.¹⁶⁻¹⁸ The chain fold lamellae can grow in area and stack to form spherulites that induce strong Mie scattering. On the other hand, side-chain crystallizable polymers (SCP) comprising long alkyl or poly(ethylene oxide) brushes have narrower phase change temperature span due to the shorter lengths of the side chains participating in the crystallization.¹⁹⁻²⁴ SCPs based on tetradecyl, hexadecyl, and octadecyl (a.k.a. stearyl) acrylates are particularly interesting as their melting and crystallization peaks shown on differential scanning calorimetry (DSC) graphs are separated by less than 10 °C, indicative of small supercooling.²⁵ This unique property is shown in the sharp modulus change of a crosslinked poly(stearyl acrylate) (polySA) by 10³ within <5 °C (FIG. 20).²⁶ The transition temperature (Tₘ) may be adjusted by the addition of tetradecyl acrylate (TA). Crosslinking via the polymer main chain should constrain the long-range movement of the alkyl chains, but apparently it does not significantly affect their local mobility. PolySA and SA-TA copolymers are opaque due to side-chain crystallization. They all become transparent above the melting point of the side chains.

This distinct and thermally induced transparency shift is not only fundamentally intriguing but also functionally advantageous. The narrow temperature span to complete the phase transition helps minimize the transition time, thermal damage to neighboring components, and energy expenditure to complete the phase change. These features are well suited for applications in smart windows, as well as in wearable electronics, bio-inspired robotics, and implantable devices.²⁷

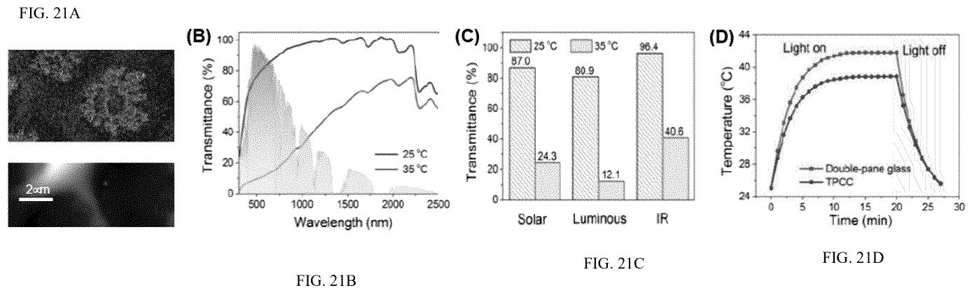

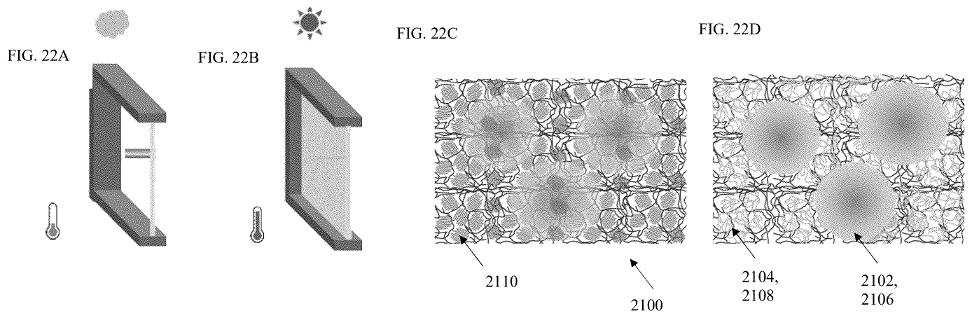

To demonstrate the SCP for tunable optical transmittance, we synthesized an SCP-terpolymer comprising hexadecyl acrylate (HDA), TA, and hydroxyethyl acrylate (HEA) at the weight ratio of 0.8:0.2:6.0. The HAD-TA mixture forms the SCP domain with Tₘ~30 °C. HEA is phase separated from the SCP domain (FIG. 21A).²⁸ Its RI matches quite closely with the —(CH₂CH₂)ₙ— side-chain crystalline domain, and the terpolymer film is largely transparent with average transmittance 80.9% in the luminous wavelength range (FIG. 21B). Above ~30 °C where the —(CH₂CH₂)ₙ— side chain crystallites melt, the terpolymer is opaque, with the mean value of modulation of solar transmittance (ΔTₛₒₗₐᵣ) ~63% (FIG. 21C). The terpolymer's ability to automatically turn opaque above ~30 °C was evaluated to control Solar Heat Gain (SHG) in a small test chamber. The temperature inside the chamber with the terpolymer film window was substantially lower than a control chamber with double-pane glass window (FIG. 21D).

The weight fraction of HDA-TA in the terpolymer was optimized to be ~15% to obtain a transmittance of ~80% in the visible region at ambient temperature. This “transparent” state, however, was still translucent due to Rayleigh scattering caused by the side chain crystallites. The opaque state of the terpolymer above ~30 °C had a transmittance of 12.1%, which was measured in the parallel direction, by convention. The parallel transmittance in the solar radiation range is 24.3%. For SHG control, the total solar transmittance across the polymer film matters the most, which was measured to be ~85% using an integrating sphere, meaning that only ~8% of solar radiation was rejected by the terpolymer film due to scattering. The low rejection ratio by scattering is caused by the low weight fraction of the SCP domain (~15%) which leads to smaller and/or less number of scattering centers above Tₘ. To improve the optical clarity of the smart window film at ambient temperature while enhancing the rejection of solar radiation above Tₘ, we must achieve an SCP with high X_{c} yet with high transparency, which has been a fundamental challenge in polymer science.

### Nanocrystallites

We studied crystal growth factors in SCPs that encourage the formation of crystalline nanophases of the crystallizable side chains but prevent the growth of the nanophases into large sizes. The resulting SCPs are termed nanophasic crystalline polymers (NCPs) which have high X_{c} but are absent of crystalline macrophases. The phase change of the nanocrystallites in NCPs in a narrow temperature span may enable the detection of temperature change, light, and force, and automatically adapt.

Such embodiments can be used to achieve a smart window film with high optical transmittance at ambient temperature and high opacity at elevated temperatures for SHG control. To this end, the transparent NCPs can be composited with RI-matched submicron-size amorphous polymer particles (μPs) to form optically transparent composite films under ambient conditions. Upon heating above the Tₘ of the nanocrystalline domains, the large RI reduction of the NCP phase leads to strong light scattering and induces opacity. This NCP-μP composite design aims to synergistically combine thermal responsiveness with optical clarity as illustrated in FIG. 22.

More specifically, we proceeded with the copolymerization of side-chain crystallizable acrylates with acrylate co-monomers that phase separate from the side-chain crystallizable acrylates at ambient temperature but are mixable at high temperatures. Copolymerization at the mixable state leads to random copolymers. In the resulting copolymers at ambient temperature, the incompatible comonomer domain suppresses the growth of large-size side-chain crystallites while not significantly diminishing the X_{c} of the crystallizable side chains in the SCP domain. Crystallizable side groups with greater change of RI (Δn) during their phase change can also be implemented. Polymer μPs with matching RI to the NCPs can be synthesized and used to synthesize NCP-μP composites films for large modulation of optical transmission.

Characterization of the microstructures and optical properties of the NCPs and composites can be performed to measure material properties and elucidate composition-microstructure-property relationships. Mechanical properties including elastic modulus, tensile strength, and loss modulus can be investigated to unravel new relationships between polymer properties and percent crystallinity. The measurements can be carried out at various temperatures to examine the modulation of the microstructure and properties during the phase transition of the crystallizable side chains.

### Second Example Composites

FIG. 21 further illustrates a composite 2100 comprising a first phase 2102 comprising a polymer; and a second phase 2104 comprising a copolymer Nanocrystalline Polymer (NCP) phase separated from the first phase. The first phase and the second phase have a matching refractive index (e.g., within 0.01) below a threshold temperature (e.g., in a range 32-45 degrees Celsius) but are different by at least 0.02 above the threshold temperature. In this example, the first phase comprises microparticles 2106 dispersed in the second phase comprising a matrix or continuous phase 2108.

The continuous phase NCP can comprise polySA+ETPTA with nanocrystallites throughout as in the first embodiment. The dispersed particles can comprise amorphous polymer microparticles (μPs) such as PMMA or poly(MMA-co-styrene), size 50 nm-10 μm

The NCP-μP composite can be designed to have higher loading of phase-change material (up to 50 vol % vs 15-30% in CPSA-HD) for greater solar rejection.

The NCP-μP composites were designed primarily for the modulation of optical transmittance. Two major potential applications are smart building windows and smart greenhouse films. For building windows, there are two key aspects concerning energy: thermal insulation and SHG. Thermal insulation is important day or night and can be improved with double pane and triple pane windows.²⁹ Meanwhile, SHG is a challenge when the sun shines directly on windows.³⁰ When this does happen, however, it is a major challenge for both comfort and climate control. A technology installed to mitigate the excessive SHG must offer a favorable balance of performance, material cost, installation cost, and operational convenience.

NCP-μP composites may be adapted for smart greenhouse films for SHG control to reduce water evaporation and electricity usage.^{31,32} This is especially true in states such as Arizona, California, and Nevada where large population centers, water scarcity, and aquifer depletion present monumental problems, with global warming and extreme heat only exacerbating these issues. For this application, the films need to exhibit large transmittance modulation in the near IR range, while transmittance in the 400-750 nm remains high for crop growth.

Smart windows on the market today for buildings are based on electrochromic and thermochromic materials that provide a certain level of SHG control.^{33,34} Both materials operate based on modulated optical absorption, which suffers from limited bandwidth, high cost, and potential overheating of the window due to solar absorption.

Switchable window technologies going from a clear state to a light diffusing or scattering state have not yet been commercialized for energy applications. For example, polymer dispersed liquid crystal (PDLC) windows are used almost exclusively for variable privacy control, due to the fact that there is so much forward light scattering through the devices that there is little SHG reduction even in the most frosted or scattering state.^{35,36} Lower critical solution temperature (LCST) windows were under development for many years by several companies, such as the “Cloud Gel” product by Suntek.³⁷ Unfortunately, the technology used water-based layers that had significant manufacturing and durability issues, such as syneresis.^{7, 38}

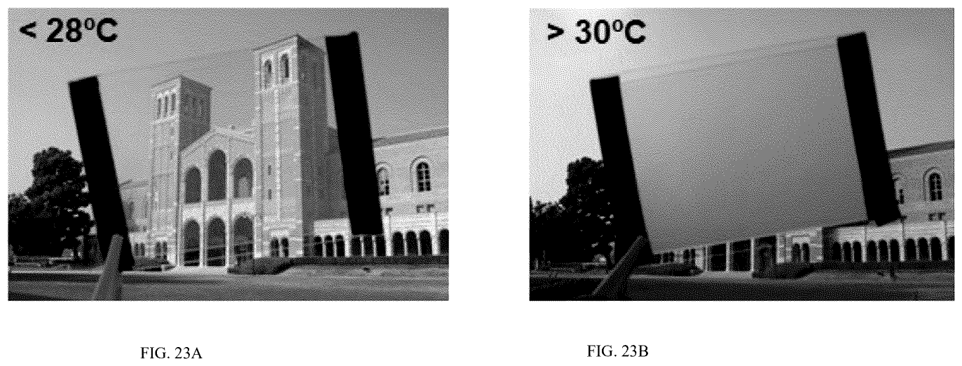

The HDA-TDA-HEA terpolymer system demonstrated up to 63% modulation of parallel transmittance in the solar wavelength range, exceeding the performance of conventional PDLC windows in switching between transparent and scattering states (FIG. 23), and highlights the potential of nanostructured thermoresponsive systems for smart windows.^{28,39} As a solid-state polymer, the terpolymer eliminates concerns over hydrostatic pressure problems in liquid and gelled systems found in LCST based hydrogel systems. The elegance of this terpolymer approach is in its simplicity: the films may be processed by conventional blade or slot die coating and UV curing, which are already widely employed in the plastic film industry. This production process is green, as it is characterized by low volatile organic compound emissions, high efficiency, and low energy consumption.⁴⁰ The terpolymer films may be deployed like wallpaper on existing windows or directly coated onto window glass. The automatic switching between opaque and clear states means that no electrical control is required, which lowers the installation cost. The NCP-μP composite film will retain all these advantages, but addresses the major challenge of achieving of greater rejection of solar radiation in hot weather. Additionally, the composite film will have little light scattering at ambient conditions to obtain clear views through the window.

The following sections discuss (1) study of NCPs with high optical transparency and large Dn during phase change, (2) syntheses of NCP-μP composites for modulation of optical transmittance, and (3) characterization of the microstructures as well as optical and mechanical properties of the NCPs and composites to elucidate composition-microstructure-property relationships during the phase transition of the crystallizable side chains.

Study of Transparent NCPs with High Crystallinity

General Considerations: In semicrystalline polymers, the co-presence of amorphous phase and crystalline phases of various sizes evinces a non-equilibrium state. Polymer chains are folded to form nanophases. The nanophases grow in area to form a lamella, and lamellae grow to form macroscopic fibrils and spherulites. As the contour length of the polymer chain is on the μm scale, a single polymer chain can extend into multiple nanophases and lamellar layers, and chains may entangle with each other. Therefore, polymer crystallization is characterized with supercooling, spanning wide temperature ranges to complete phase change, and the resulting morphology is metastable.

There are reports to render main-chain crystallizable polymers transparent for applications requiring both high mechanical strength (high X_{c}) and optical clarity.^{12,41} Crosslinking polyethylene glycol in an epoxy resin network was shown to confine the polyethylene glycol main chain crystallites to sub-μm size to obtain transparency in thin films.⁴² Nylon 4/6 and nylon 4 copolymers were made crystalline and transparent when the nanocrystallite size was in the range of 4-8.3 nm due to the unique stereoregular structure of the nylon 4/6.⁴³ The drawn fibers of highly crystalline polyethylene films processed from a hot decalin solution via Couette-flow extrusion with a draw ratio of 110 exhibit metal-like thermal conductivity as the amorphous chains are reduced to small volume fraction and domain size.⁴⁴

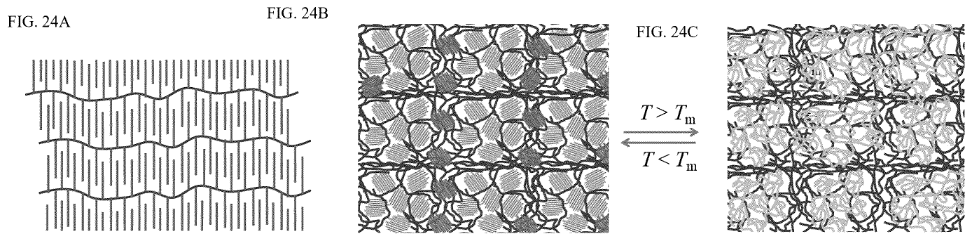

SCPs such as polySA are opaque similar to main-chain crystallizable polymers at high X_{c}. The octadecyl side chains in polySA form a unique molecular layer morphology where the side chains interdigitate into each other as shown (FIG. 24A) or in end-to-end form.^{19,20} Side-chain length and main-chain stiffness may alter the layered structure. Information is limited about how the molecular layer grows into micro- and macrophases. Our preliminary study shows that uncontrolled growth could lead to spherulite-like macrophases (see FIG. 24A). The growth of the molecular layers in 3 directions (growth of the plane along the polymer chain and vertically, and stacking of the layers can be studied, see further discussion below).

In order to break the long-range packing orders and thus prevent the growth of nanocrystallites into large sizes, a copolymerization strategy is proposed using acrylates that are incompatible with SA at ambient temperature but mixable at high temperatures. Curing at the mixed state leads to a somewhat random copolymer. Upon cooling to ambient temperature, the phase separation of the comonomers allows the aggregation of the octadecyl side chains (FIGS. 24B & 24C). The crystallization of the side chain aggregates is thus less interfered by the presence of comonomers. Meanwhile, long-range diffusion is suppressed due to the high interfacial energy between the incompatible comonomer domains. Crosslinking may further stabilize the phase-separated network morphology. This strategy can be explored to synthesize the NCPs, because it may offer two important benefits: (1) the crystallization and melting may exhibit certain features of small molecules: T_{c} and Tₘ nearly overlap, and both have a narrow temperature span; and (2) the phase change can be highly reversible as the absence of long-range diffusion allows the phase transition to quickly reach equilibrium.

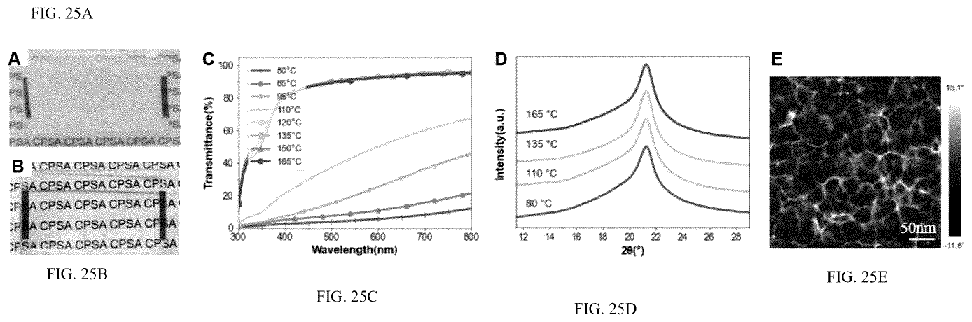

Preliminary Results: To demonstrate the validity of this strategy, copolymers of SA and ethoxylated trimethylolpropane triacrylate (ETPTA) were prepared. SA and ETPTA are incompatible at room temperature up to 100 °C. Curing of the mixture at this incompatible state led an opaque material which remained opaque at elevated temperatures (FIG. 25A). At >120 °C, the two monomers formed a clear solution, and the high optical clarity was retained when the solution was cured upon ultraviolet light exposure at the elevated temperature (FIGS. 25B & 25C). The clear poly(SA-co-ETPTA) exhibited the characteristic X-ray diffraction (XRD) peak of polySA at 2θ~21° (FIG. 25D). The average crystal size estimated using the Scherrer equation was 3.2-4.0 nm based on the line broadening at half of the maximum intensity. Phase mode atomic force microscopy (AFM) shows that the average SCP domain size in the NCP is ~15 nm (FIG. 25E), and ETPTA forms a network structure separating the SCP domains.

The NCP microstructure of poly(SA-co-ETPTA) polymerized above 120 °C is postulated to consist of nm-scale domains of the SCP caged by an incompatible network formed by the incompatible co-monomer (or crosslinker). The phase transiton of the SCP side chains can be completed in less than 30 s in both directions, limited often by heating rate and slow heat conduction in thick films. The high optical transmittance of the films was retained after 1000 cycle of heating/cooling cycles, so was the X_{c}.

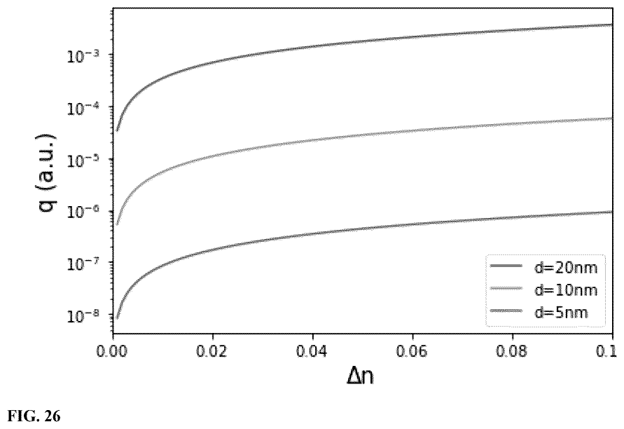

Optical Transmittance Estimated by Rayleigh Scattering: For a quantitative consideration of the clarity of NCP films, the intensity of scattering radiation (I) may be estimated by the Raleigh equation

$$I = {I}_{0} ( \frac{1 + {cos}^{2} θ}{2 {R}^{2}} ) \times q$$

$$q = {( \frac{2 π}{λ} )}^{4} {( \frac{{n}^{2} - 1}{{n}^{2} + 2} )}^{2} {( \frac{d}{2} )}^{6}$$

$$n = \frac{{n}_{p}}{{n}_{p} - Δ n} \qquad ( 1 )$$

where I₀ is the incident light intensity, q is the scattering angle, R is the distance to the observer, l is the wavelength of incident light, d is the diameter of scattering spheres, and nₚ is the matrix RI. Equation (1) was originally developed for optically soft and small-sized particles, i.e., Δn between the particle and its matrix is small and particle size is small compared to the wavelength of light to incur the Rayleigh scattering. The lumped value q describes the scattering effect regardless of the scattering angle and observing distance.⁴⁵ FIG. 26 plots the q values at various d and Δn in the ranges that are relevant to this study. It shows that as d is increased from 5 nm to 20 nm, q increases by 4 order of magnitude. Therefore, it is important to confine the crystallites in the NCPs.

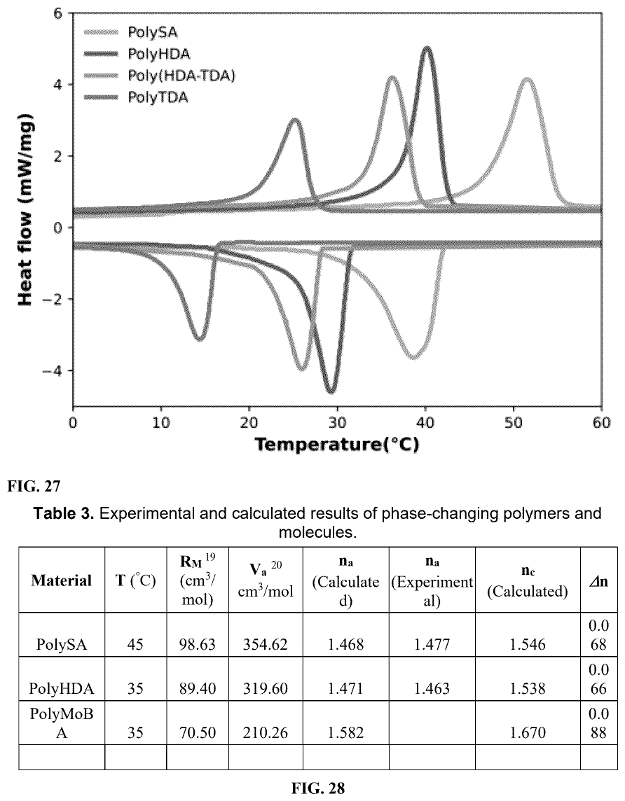

Crystallizable Side Groups: The n-alkyl acrylates with the n-alkyl chain containing 14-18 carbon atoms are convenient choices for the study of the NCPs due to the availability of these acrylates and the ease of synthesizing copolymers via free-radical bulk polymerization. The different n-alkyl chain lengths lead to different phase change temperatures (FIG. 27). Since the crystallizable moieties in these acrylates are the same, —(CH₂CH₂)ₙ—, these n-alkyl chains may be mixed for fine tuning of the phase change temperature without substantially altering the percent crystallinity.

For smart window applications, one study shows that a good transition temperature is 39 °C with air conditioning (AC) and 42 °C without AC.^{46,47} While the ideal transition temperature may vary based on the modulation mechanism of the smart window material, geographic locations and personal thermal comfort preferences, the 39-42 °C range is a good starting for this study. From FIG. 27, this range is below the Tₘ of polySA and above that of polyTDA. Therefore, the combination of SA, HAD, and TDA will allow us to tune the phase change temperature while studying the overall Δn of the material system for large modulation of optical transmittance as further described below.

The Δn during the phase transition of organic polymers may be estimated using the Lorentz-Lorenz Equation based on the molar volumes at the crystalline and amorphous states.⁴⁸ In the transition from a 100% crystalline to amorphous state:

$$Δ n = {n}_{c} - {n}_{a} = \sqrt{\frac{1 + 2 ( {R}_{M} / {V}_{c} ( T ) )}{1 - ( {R}_{M} / {V}_{c} ( T ) )}} - \sqrt{\frac{1 + 2 ( {R}_{M} / {V}_{a} ( T ) )}{1 - ( {R}_{M} / {V}_{a} ( T ) )}}$$

where R_{M} is the molecular refraction of the polymer repeating unit and V is the molecular volume at a specific temperature T. Table 3 in FIG. 28 shows the input data and calculated results for polySA, polyHDA, and poly(p-methoxybiphenyl acrylate) (polyMoBA). Experimentally measured nₐ of polySA and polyHDA are also shown, which are in close range to their respective calculated values.

The calculated Δn for polyHDA is 0.066 for the transition between amorphous (X_{c}=0%) and crystalline (X_{c}=100%) states. The measured Δn for the experimental polyHDA is 0.04 during its phase transition at 35-40 °C. The difference between the experimental and calculated Δn reflects that the X_{c} of the experimental material which is ~66% based on the latent heat determined via DSC. PolyMoBA has a calculated Δn of 0.088, larger than that of polyHDA, due to its aromatic structure and stronger intermolecular π-π interactions compared to the weak van der Waals forces in polyHDA. Side groups consisting of polar groups such as cyano and ester groups can be explored to further increase Δn up to 0.10.

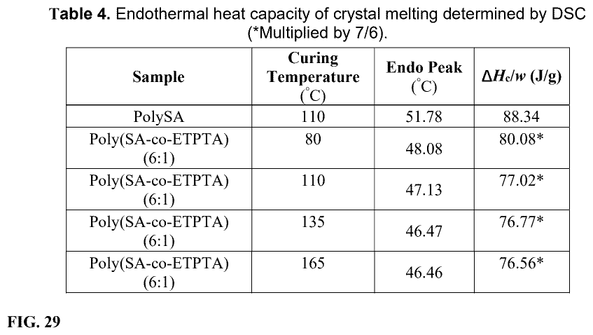

Suppression of the Size of Side-Group Crystallites via Incompatible Co-monomers: The poly(SA-co-ETPTA) copolymer in our preliminary study used two monomers of vastly different solubility parameters, with SA being hydrophobic whereas ETPTA is somewhat hydrophilic, leading to severe phase separation at room temperature. Their mixability improved with rising temperature, and the mixture became clear above 120 °C. It is unknown whether the comonomers form a molecularly dissolved solution or a phase-separated mixture with at least one phase being of the nm scale. Copolymerization of the clear liquid solutions leads to clear films. Table 4 in FIG. 29 shows that the crystal melting temperature decreases with higher curing temperature, in agreement with smaller crystal size. The latent heat determined by differential scanning calorimetry (DSC) also decreased, but only by a small amount; it was 77 J/g of SA for the clear poly(SA-co-ETPTA) cured at 135 °C, which is 88% of the latent heat in pure polySA. This indicates that the X_{c} of the crystallizable side chains in the clear copolymer remains high. Thus, the incorporation of an incompatible comonomer is considered an effective strategy for synthesizing NCPs.

ETPTA is also an effective crosslinker as it contains 3 acrylate functional groups in the compound. However, crosslinking alone does not result in the NCP formation, as demonstrated via the copolymerization of SA and trimethylolpropane triacrylate (TMPTA) at molar ratios from 6:1 (same as in poly(SA-co-ETPTA)) up to 30:1 (where the crosslink density is 50% that of poly(SA-co-ETPTA). The resulting poly (SA-TMPTA) are all amorphous. The effect of network formation in NCPs is further described below.

We have also explored several acrylates having bulky side groups, such as cyclohexyl acrylates and benzyl acrylates as the incompatible comonomer to SA. The resulting copolymers were also transparent. However, XRD showed that the n-octadecyl chains in the copolymers were not crystalline. We suspect that the crystallization of the n-octadecyl chains is disrupted due to the small difference in cohesive energy density of the n-octadecyl, cyclohexyl, and benzyl groups, which are all comprised of low-polarity C—C and C—H bonds. As a result, these side chains are molecularly miscible within the polymer matrix, leading to an amorphous morphology. To the other extreme, acrylates that are highly hydrophilic, such as hydroxyethyl acrylate and hydroxyethyl methacrylate, do not form a clear solution with SA even at extremely high temperatures. ETPTA appears to have the proper incompatibility with SA for the synthesis of NCPs.

To identify suitable co-monomers to effectively reduce the side-chain crystallite size without significantly diminishing the X_{c}, the Hansen solubility parameters (HSP) could be used as a general guideline. Three parameters are used to estimate the HSP distance between molecules in mixing:⁴⁹

δD, the “Dispersion” parameter that correlates with the polarizability of a molecule, or its number of polarizable electrons. Saturated molecules like long n-alkyl groups have few polarizable electrons so their δD are low, but aromatics like benzyl have more polarizability due to the delocalized π-electrons so their δD are higher.

δP, the “Polar” parameter that correlates with polar groups such as —OH or —C═O.

δH, the “Hydrogen bonding” parameter that is obvious in terms of molecules such as HEA (hydroxyethyl acrylate). The ester group in the acrylates has a modest δH because the carbonyl group is an acceptor for hydrogen donors.

The compatibility of two different co-monomers can be estimated by their HSP Distance defined as:

Distance²=4(δD₁-δD₂)²+(δP₁-δP₂)²+(δH₁-δH₂)²

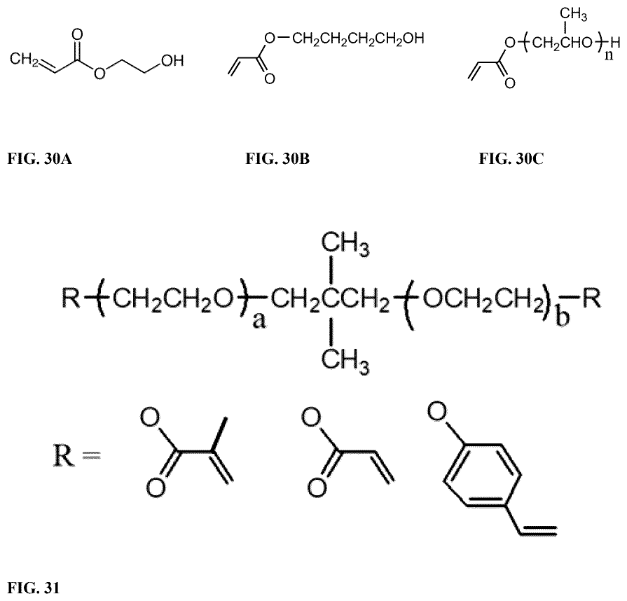

The HSP parameters reported in the literature could be used to estimate the HSP Distance of a variety of co-monomers with the crystallizable side groups studied herein. Co-monomers ranked from large to small HSP Distance can investigated to identify suitable co-monomers to synthesize NCPs. FIG. 30 shows three exemplary acrylates. HEA has the highest polarity among the three. Hydroxybutyl acrylate has a longer alkylene chain —(CH₂)ₘ— than HEA and is expected to offer improved compatibility with n-alkyl chains compared to HEA. The HSP Distance of stearyl acrylate, HDA, and TDA could be determined with a series of hydroalkyl acrylates of different m values, and correlation of the Distance to the percent crystallinity as a function of the size of the n-alkyl side chains.

Polypropylene glycol monoacrylate is another series of co-monomers of interest (FIG. 30). The —OH end groups provide a large δP and δH, while the propoxy group offers modest δP and δH to allow adjustment of the HSP Distance. The number of the propoxy units, n, offers a convenient way to tune the HSP Distance. It will be interesting to examine whether the propoxy unit chain length being shorter, equivalent, or longer as compared to the n-alkyl chains makes a major difference in the percent crystallinity and crystallite size.

Replacing the n-octadecyl acrylate with MoBA and other acrylates incurring large Δn during the phase transition of the side chain introduces a new series of NCPs. The HSP Distance values calculated based on literature data can be used to select the corresponding incompatible comonomers. The temperature and concentration to attain clear solutions of the comonomers will be experimented.

Suppression of Side Group Crystallite Size in Crosslinked Network: This strategy explores the copolymerization of SCP monomers with incompatible crosslinkers, to obtain in-depth understanding of the network effect in the NCP formation. A series of difunctional monomers such as those shown in FIG. 31 can be used. There are three parameters that could play a role in the formation of NCPs with these comonomers, the first of which is the HSP Distance values of the network formers with the SCP monomer.

Secondly, the relative reactivity of styrene, acrylate, and methacrylate generally follows r_{St}>r_{A}c>r_{MA}.⁵⁰ The reactivity may vary based on the attached groups and specific reaction conditions. The styrene groups are linked to the network chain via —O— with the consideration that the ether group further enhances the reactivity of styrene and the synthesis of the co-monomer is straightforward with high yield. Comparative study of styrene, acrylate, and methacrylate-based network formers will reveal how polymerization sequence (SCP monomer first or network first), i.e., preforming the network, post-forming the network, or random copolymerization, impacts the NCP formation.

Finally, the network chain length, i.e., the value of (a+b) is also an important parameter affecting the size of the cage formed by the crosslinkers. FIG. 25E shows cage size around 15 nm, we speculate that altering the cage size may offer new insights to the NCP nanophases.

d. Syntheses of NCP-Based Composites

General Considerations: The acrylate groups of the co-monomers forming the NCPs allow for the synthesis of NCP-based composites via bulk polymerization. Composite films may be directly formed from the liquid solutions containing the co-monomers and additives via thermal or UV-initiated free-radical polymerization. No solvent is used and no side products need to be removed. This approach can lead to low-cost production of large-area films for smart window applications. Submicron-size polymer mPs composited in the NCP have matching refractive index with the NCP at ambient temperature. The mPs remain amorphous when the NCP transitions between its crystalline and amorphous states. Therefore, the composite is transparent at ambient temperature and becomes opaque above the Tₘ of the nanophasic domains in the NCP to block the transmittance in the solar radiation wavelength range.

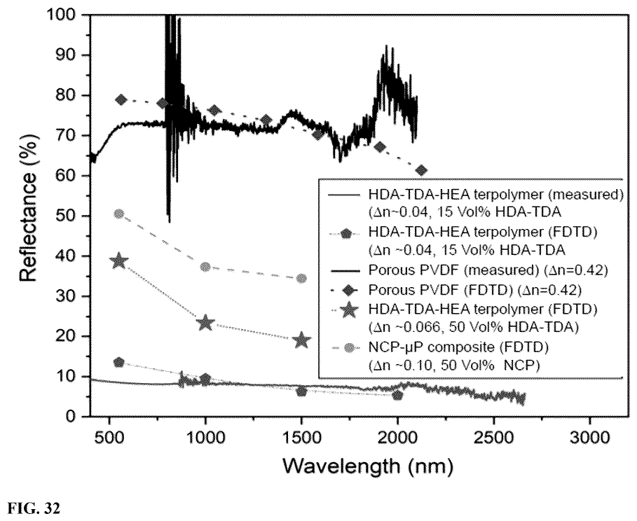

Simulation of Reflectance in the Solar Spectral Range: The preliminary HDA-TDA-HEA terpolymer film (0.8:0.2:6.0 by weight) shown in FIG. 21 exhibited 85% parallel transmittance, which decreased to just 24.3% above 30 °C. The transmittance at the clear state diminishes with higher loading of the phase-change HDA-TDA phase. The total transmittance at the opaque state, which measures the percent light penetrating through the film, is ~84%. Reflectance measurement showed that only ~8% of the light is scattered back (FIG. 32, (a)). Two major factors contribute to the low light rejection: the low volume ratio of the HDA-TDA phase in the terpolymer and the relatively low Dn~0.04 of the HDA+TDA phase during its crystalline-amorphous transition.

To introduce computer-aided material synthesis, we have preliminarily developed a 3-dimensional finite-difference time-domain (FDTD) model to correlate the reflectance of the HDA-TDA-HEA terpolymer film at the opaque state to the volume fractions of the two separated phases, Dn, and film thickness.⁵¹ The protocol treats a composite film as a 3-D mesh of discretized 100 nm-size cells. The simulated reflectance of the terpolymer film with 100 μm thickness matched quite well with the experimentally measured reflectance as shown in FIG. 32, (a). The high noise on the experimental reflectance spectrum was due to the measurement setup. This will be further discussed below.

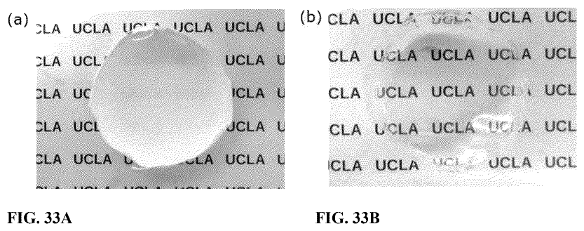

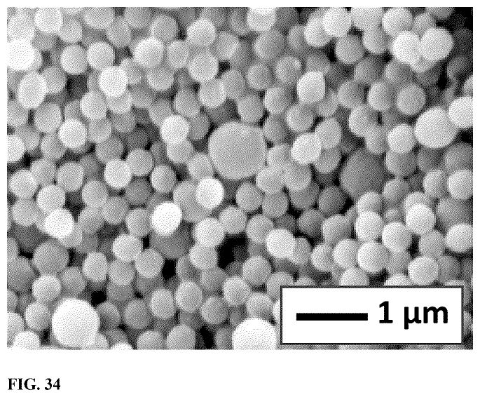

To further validate the FDTD protocol, we examined a poly(vinylidene difluoride) (PVDF) porous film with a very high Dn of 0.42 (between PVDF and air). The film was experimentally synthesized by casting a composite film comprising PVDF and ZnO nanoparticles and subsequently dissolving the ZnO particles with hydrochloric acid. The dried porous film appeared white; much of the incident light was rejected due to strong scattering in the film (FIG. 33A). At 50% porosity, average pore size of ~800 nm, and 100 μm thickness, the reflectance of the film was measured to be >70% in the solar spectral range (FIG. 32, (a)). The film turned transparent when immersed in an RI-matching liquid (FIG. 33B). FDTD simulation showed similar reflectance values.

These results confirmed the efficacy of our 3-D FDTD protocol. We further examined the reflectance of a hypothetical HDA-TDA-HEA terpolymer with the HDA-TDA phase being ~50 vol %. The FDTD simulation was performed assuming Dn=0.066, the reflectance increased to 39% at 550 nm (FIG. 32, (c)). If Dn is further elevated to 0.10, which is targeted in the synthesis of new NCPs described above, the reflectance would be 51% at 550 nm and 34% at 1500 nm (FIG. 32, (d)).

The FDTD simulation in the preliminary study was limited by the geometrical complexity of the structure and the mesh size of the model. In order to accurately describe the ~800 nm scattering particle size and 100 μm film thickness of the experimental composites, mesh cell size less than 50 nm, or 10% of the scattered light wavelength, is required to accurately simulate the light propagation across cells. Such a 3-D FDTD model with ~2000 cells is computationally prohibitive for us. A 3-D FDTD could also be used to simulate the scattering efficiency of a single particle, then use the resulting angular scattering efficiency to trace 100,000 or 1,000,000 rays in the targeted films. Based on the ray number and angle distribution collected by the monitors, the reflectance and transmittance of the films can be accurately determined.⁵² This ray tracing method can be applied at various percent volumes of scattering particles, particle size, and Dn values. Results could be used ot provide guidance in the selection of the μPs to obtain high reflectance and large modulation of optical transmittance in the NCP-μP composites.

Synthesis of NCP-μP Composites: In one embodiment, mPs having matching refractive index with the NCP can be synthesized. The synthetic chemistry for polymer particles is quite mature, with the literature reporting a wide variety of polymer particles, ranging in size from a few nm to several μm, and having either a narrow or broad size distribution. Microemuslsion polymerization in oil in water mixture and surfactants is a popular technique to synthesize polymer particles tens of nm in size, and it works equally well for copolymer particles.^{53,54} By injecting the co-monomers in steps, particles with diameter ~300 nm can be synthesized.⁵⁵ We preliminarily synthesized poly(methyl methacrylate) (PMMA) mPs using the microemulsion technique, with an nonionic surfactant (nonylphenol ethoxylates) at different concentrations and temperatures in order to obtain mPs for the scalable synthesis of the NCP-mP composites. FIG. 33 displays the preliminary mPs with hundreds' nm diameters. The particle size distribution is fairly broad, which is considered suitable for the proposed application such that photonic crystal effect leading to colored reflection is avoided.

To match the RI of the polymer mPs with the NCP matrix, mPs comprised of two or more different monomers can be synthesized. The RI of the homopolymers of MMA and styrene are 1.4893 and 1.5894, respectively. Their copolymers allow the tuning of RI between 1.4893 and 1.5894. The RI of crystalline polySA is 1.54, within the RI range covered by the MMA-styrene copolymers. The new NCPs with greater Δn in crystalline-to-amorphous transition than polySA will likely have higher RI values than polySA. Table 3 shows that the RI of amorphous polyMoBA is 1.582, which is still in the range of the MMA-styrene copolymer particles. Further modification include synthesizing polymer mPs from copolymers of methyl methacrylate and styrene. Crosslinkers such as divinylbenzene and trimethylolpropane trimethacrylate could be incorporated to minimize swelling by the NCP-forming co-monomer solutions. Crosslinking usually alters the density of amorphous polymers, and thus offer an additional means to fine tune the RI for optimal index matching. Particle sizes in the range of tens to hundreds nm with broad size distribution are targeted.

Phase separation in the mPs due to different reactivities of the comonomers can affect the optical clarity of the mPs and consequently the NCP-mP composites only if the phase domains are ~10 nm or larger. We do not anticipate this to be an issue, but if phase separation is severe, co-monomers with reactivities close to each other, such as methyl acrylate and naphthyl acrylate, can be chosen.

The as-prepared mPs will be isolated via centrifugation, thoroughly washed to remove excess surfactants, and subsequently dried. To facilitate dispersion of the mPs in the NCP-forming formulation, several strategies may be studied, including (1) surface functionalization of the mPs—such as conversion of the —OH groups into acrylate or oleic acid ester, (2) high-shear mixing, and (3) processing at elevated temperatures. Since some of these conditions may impact the optical clarity of the resulting NCP phase, a comprehensive optimization strategy can be employed to balance and enhance performance across all critical material properties.

e. Characterization and Measurements

The synthesized materials, including the SCP monomers, NCP polymers, and polymer mPs, can be characterized by conventional molecular analysis, micro- and nano-structural imaging, and measurements of optical and mechanical properties. The following are characterizations that are relatively unconventional and warrant detailed description.

Microstructural Characterization: There are two size scales of the microstructure in the NCP and composites. One is the nanocrystallites in the NCP, which are on the order of ~10 nm or smaller. Scanning electron microcopy, transmission electron microscopy, and atomic force microscopy could be used to image the nanocrystallites in contrast to the amorphous domain. Wide-angle XRD (WXRD) and small angle X-ray scanning (SXRS) could be used. WXRD shows the diffraction peak at 2θ~21° (see FIG. 25D), which gives the interchain distance for the crystallized n-octadecyl chain in hexagonal lattice. The shifting of the peak position and peak broadening can be used to study factors such as comonomers and temperature that can affect the packing density and crystal size. SAXS is a powerful tool to study the lamellar spacing (e.g. FIG. 25A). The octadecyl side chains are known to be polymorphic, taking interdigitating form or end-to-end form.²⁰ SAXS could reveal the side chains packing in the NCP, and factors that alters the packing such as the incompatible co-monomer network, polymer backbone, and crystallization temperature.

Thermal Characterization: DSC is useful to determine the phase change temperatures, the enthalpies involved in the phase change, and X_{c} and to study the complex thermal events in the nanophases of the NCP and the composites (e.g., DISCOVERY DSC250, a modulated DSC (MDSC) offered by TA Instruments). This intrument offers excellent performance in baseline flatness, sensitivity, resolution, reproducibility, and reliability. The included TRIOS software provides versatile programming and data analysis. This MDSC will allow for the separation of overlapping thermal events, including both reversing (heat capacity-related) and non-reversing (kinetic) transitions.⁵⁶ MDSC is particularly useful to study the glass transitions and different stages of crystallization and melting for the multiple domains at different size scales in the NCPs and composites.

Mechanical Properties: Understanding the structure-mechanical property relationships of the NCPs during the phase transition holds significant implications for applications robotics, wearable devices, stretchable electronics, and bioimplantable systems.^{27, 57} Some of the SCPs we have studied exhibited ~3 orders of magnitude change in modulus in the phase transition (see, e.g. FIG. 20).^{25,26,58} The new NCPs from this study will have larger Δn than the previous SCPs, and as such may exhibit even greater modulus variation. The polymer and composite samples can be tested using an RSA-III dynamic mechanical analyzer already installed in our lab. This equipment allows for tensile stress-strain testing and dynamic mechanical testing under sinusoidal stretching conditions at small strains, in a wide temperature range. The tensile modulus, tensile strength, storage modulus, and loss modulus will be determined and correlated with the materials' composition, X_{c}, and phase-separated microstructures.

Measurement of Refractive Indices: A NAR-IT Abbe refractometer with a fixed wavelength of 589 nm can be used to measure refractive index. There is no standard technique to measure the refractive index of microparticles. In some embodiments, for the μPs synthesized an indirect method can be used, by index matching with a mixture solvent comprising two liquids, one with a higher refractive index than the μPs and one with a lower refractive index.⁵⁹ The protocol involves adding the μPs to the higher refractive index liquid to yield a translucent dispersion, then adding the lower refractive index liquid in small increments until the dispersion turns transparent. The refractive index of the transparent dispersion is subsequently measured with the refractometer.

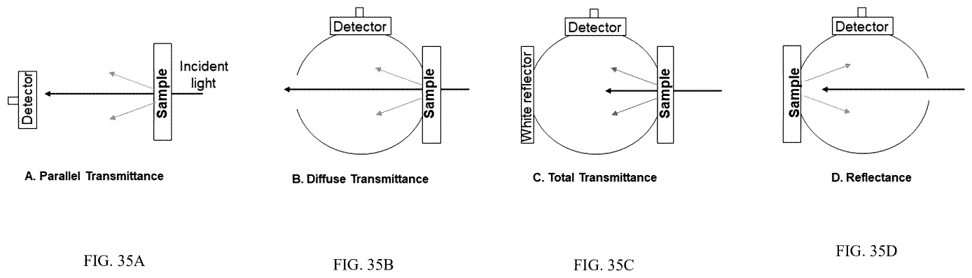

Measurement of Optical Transmittance and Reflectance: A Shimadzu UV-3600i Plus spectrophotometer can be used for the optical measurements in the wavelength range from 185 to 3300 nm. An integrating sphere can be integrated in the spectrophotometer to allow for measurements of reflectance and the various transmittances as illustrated in FIG. 35. The measurements can be calibrated with a reference light beam. The total transmittance measures all transmitted light through a sample captured inside the integrating sphere, while the diffuse transmittance measures the total transmittance minus the transmitted light in the parallel direction. The reflectance can be measured when the sample is mounted opposite to incident light. The total reflectance can determined when all the reflected light is captured in the integrating sphere. It measures the fraction of light rejected by the sample.

Testing of Solar Heat Gain Control: Temperature change inside a styrofoam chamber (FIG. 5) covered with NCP-μP composite films can be monitored continuously using A Pico TC-08 USB thermocouple Data Logger. A reference chamber covered by a double-pane glass will also monitored next to the sample chamber. Films showing substantial solar heat gain control will be fabricated to 1 sq.ft area per sheet.

Evaluation of Phase Transition Stability: To evaluate the long-term structural and functional stability of the NCP NCP-μP composite films, their phase transition behavior under environmental and thermal stress can be investigated. The composite films can undergo accelerated aging under controlled environmental conditions to simulate prolonged exposure to heat (85 °C) and humidity (75%). This testing regime is designed to reveal potential degradation mechanisms, such as morphological change, loss of phase-change reversibility, and degradation of optical transmittance or structural integrity over time. To assess the films' durability under repeated phase transitions, thermal cycling can be performed using a custom-designed heating block system. This system can be equipped with a programmable temperature controller, embedded thermocouples for real-time monitoring, and electrical heating elements to deliver precise and repeatable heating/cooling cycles. The films can be cycled between 30 °C and 50 °C, which corresponds to the operational temperature range relevant for phase change behavior. After each environmental or thermal treatment condition, the samples will be characterized using the techniques outlined in preceding sections. The goal is to establish a comprehensive understanding of how the phase-change performance and structural fidelity respond to environmental and operational stresses, ultimately informing their suitability for long-term use in smart windows and other devices.

### 5. Advantages and Improvements

A key aspect of the invention is the discovery of a transparent semicrystalline polymer described. Transparency is for visibility and semicrystallinity is for high mechanical strength in a smart window. This invention presents transparent semicrystalline copolymers composed of a majority co-monomer whose polymer is highly crystalline and a minority comonomer which is non-compatible with the majority comonomer. As an example, poly(stearyl acrylate) (poly (SA)) is highly crystalline due to its long alkyl chains. Ethoxylated trimethylolpropane triacrylate (ETPTA) is a trifunctional monomer. SA and ETPTA are not compatible and are phase separated at ambient temperatures. Their mixture forms a transparent liquid at elevated temperatures at which the two monomers are copolymerized to form a transparent copolymer which remains clear at both the elevated temperatures and when cooling down to ambient temperatures.

With the new formula shown here, the performance of smart windows has been dramatically improved. Both the transparent at ambient temperature and the modulation of transmittance at heated temperature are far better than we previously obtained.

The semicrystalline polymer can be a phase changing polymer combined and phase separated from another polymer with refractive index match and mismatch at low and high temperatures, respectively, to achieve optical modulation in a smart window.

### Process Steps

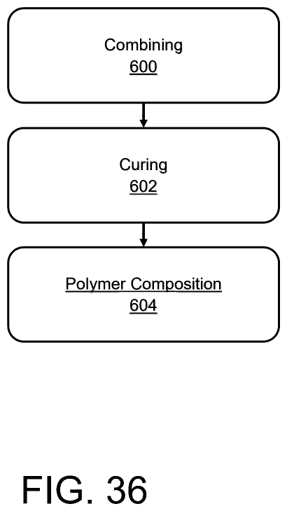

FIG. 36 illustrates a method of making a polymer useful as a coating or window or precursor for a smart window can comprise the following steps.

Block 600 represents combining a plurality of monomer precursors with a separate phase to form a mixture. In one embodiment, the method comprises solution processing a plurality of monomer precursors with appropriate ratios to form a precursor mixture. Other additives, e.g., for refractive index adjustment or photointiators, may be added.

Block 602 represents heating and/or curing the precursor mixture with ultraviolet radiation to increase a temperature of the mixture to above a threshold temperature (e.g., 120 degrees Celsius) to form the polymer of any of the claims 1-23. In one or more embodiments, the step comprises heating the mixture to an elevated temperature (e.g., 120 degrees Celsius or above) wherein heating forms a clear liquid solution (no cloudiness) of the first comonomer and the second comonomer at the elevated temperature, the clear liquid solution being visibly transparent and/or comprising a single homogeneous phase and/or a visible transmittance greater than 90% for electromagnetic radiation having wavelengths in a range 380-780 nm. The step can comprise exposing the heated precursor mixture to ultraviolet radiation to initiate polymerization reactions via a photoinitiator.

In one embodiment, the threshold temperature is 120 degrees Celsius.

In one or more embodiments, the precursors comprise the first co-monomer, the second co-monomer and optionally at least one of the third co-monomer, the additive, the non reactive small molecule, or the fourth co-monomer. Example appropriate ratios are such that the first comonomer forms a polymer that is at least 75% by weight of the copolymer and optionally the third comonomer forms a polymer (e.g., poly(HEMA)) that is at least 30% of the synthetic polymer, or composite, by weight, and further comprising 5-20% of the additive by weight of the second continuous phase.

Block 604 represents the result, a polymer composition. The steps can form a composite comprising a first phase comprising a copolymer and a second phase comprising a polymer phase separated from the first phase; wherein the first phase and the second phase have matching refractive indices below a threshold temperature of 35-42 degrees Celsius but mismatched refractive indices above the threshold temperature.

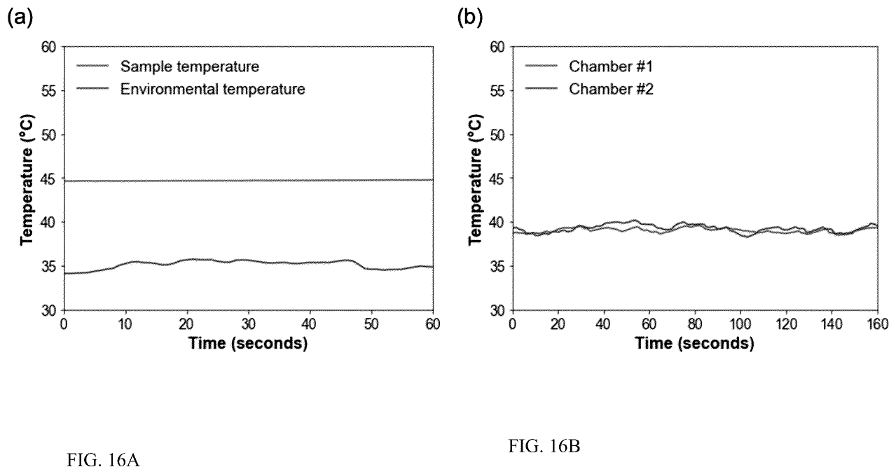

Embodiments include, but are not limited to, the following compositions of matter and methods and devices (referring also to FIGS. 1-35).
1: A transparent semicrystalline copolymer 100, 2104 composed or or comprising of at least:
(e.g., repeat units polymerized from) a first comonomer whose homopolymer is semicrystalline; and
(e.g., repeat units polymerized from) a second comonomer which forms a phase separated mixture with the first comonomer at a low temperature and the mixture turns transparent at an elevated temperature;
and the copolymer retains no less than 25 percentage of crystallinity relative to the homopolymer of the first comonomer.
2: The transparent semicrystalline copolymer of claim 1, wherein the first co-monomer comprises at least 75% by weight of the copolymer, and the copolymer retains no less than 50 percentage of crystallinity relative to the homopolymer of the first comonomer.
3: The transparent semicrystalline copolymer of any of the claims 1-2, wherein the first and the second co-monomers are copolymerized at an elevated temperature at which the two comonomers forms a clear solution.
4: The transparent semicrystalline copolymer of any of the claims 1-3, wherein the first comonomer is selected from the group consisting of stearyl acrylate, hexadecyl acrylate, tetradecyl acrylate, lauryl acrylate, N-docosyl acrylate, and the second comonomer is ethoxylated trimethylolpropane triacrylate.
5: A synthetic polymer 104 comprising the transparent semicrystalline copolymer of any of the clauses 1-4, further comprising at least a third comonomer which is phase separated from the clear liquid solution of the first and second comonomers at the elevated temperature.
6: The synthetic polymer of clause 5, further comprising an additive which is dissolved in the phase formed by the third comonomer to adjust its refractive index.
7: The synthetic polymer of clause 6, wherein the additive is a non-reactive small molecule.
8: The synthetic polymer of clause 6, wherein the additive is a fourth co-monomer.
9: The synthetic polymer of any of the clauses 5-8, further comprising an additive (e.g., the non reactive small molecule or the fourth monomer) which is dissolved in the clear liquid mixture of the first and second comonomers to adjust the refractive index of the clear liquid mixture.
10. The synthetic polymer or copolymer of any of the clauses 1-9 wherein the third comonomer is hydroxyethyl methacrylate.
11. The synthetic polymer of any of the clauses 5-10 wherein the additive is diethylene glycol.
12. The synthetic polymer of any of the clauses 5-11 comprising:
a first phase comprising the copolymer comprising poly(stearyl acrylate), poly(hexadecyl acrylate), poly(tetradecyl acrylate), poly(lauryl acrylate), or poly(N-docosyl acrylate) main chains crosslinked with ethoxylated trimethylolpropane triacrylate; and
a second phase comprising poly(hydroxyethyl methacrylate) (poly (HEMA)) phase separated from the first phase.
13. The synthetic polymer of clause 12, wherein the first phase further comprises one or more normal-alkyl side chains (N—CₙH₂ₙ₊₁ where n is 12 or larger) connected to the main chains. This can cover odd-numbered alkyl chains such as C₁₅H₃₁, for example.
14. The synthetic polymer of clause 12, wherein the poly (SA) is at least 75% by weight of the copolymer and the poly (HEMA) is at least 30% of the synthetic polymer by weight.
15. The synthetic polymer of any of the clauses 12-14 further comprising 5-20% of the additive by weight of the second phase.
16. The synthetic polymer or copolymer of any of the clauses 1-15, wherein the copolymer:
crystallizes to form nanocrystallites each having a maximum dimension less than 100 nm at a temperature below a threshold temperature (e.g., in a range of 35-42 degrees Celsius), wherein the synthetic polymer is transparent; and
above the threshold temperature, the nanocrytsallites melt by undergoing a glass transition into an amorphous state so that solar electromagnetic radiation, having wavelengths in a range of 300 nm-2500 nm, scatters from phase boundaries between the separated phases ot render the synthetic polymer opaque.
17. The synthetic polymer or copolymer of clause 13 and 16, wherein the sidechains crystallize to form the nanocrystallites and melt into the amorphous state.
18. A composite 104 comprising the transparent semicrystalline copolymer of any of the clauses 1-17 and at least a phase separated additive.
19. The composite of clause 18, wherein the phase separated additive is a particle with a size larger than 50 nanometers but smaller than 10 micrometers, ethylene glycol, or a polymer different from poly (HEMA).
20. A composite or film 104, comprising:
a continuous phase comprising a polymer 106;
particles 110 comprising a copolymer dispersed within the continuous phase 112; and
the continuous phase and the particles have matching refractive index (e.g., to within 0.01).
21. The composite or film of clause 20, wherein the continuous phase comprises poly(hydroxyethyl methacrylate).
22. The composite or film of clause 20 or 21, wherein the copolymer 109 comprises a plurality of nanocrystallites 114 having a maximum dimension or crystal size (as measured from an X-ray diffraction peak by the Scherrer equation) of 100 nm or less below a threshold temperature 35-42 degrees Celsius, and wherein above the threshold transition temperature the particles are amorphous.
23. The composite or film of any of the clauses 17-22, wherein the copolymer comprises a polyacrylate with long n-alkyl chains (e.g., but not limited to) poly(hexadecyl acrylate), poly(tetradecyl acrylate), poly(lauryl acrylate), or poly(N-docosyl acrylate).
24. The composite or film of any of the clauses 1-23 wherein the copolymer comprises or is formed from the transparent crystalline copolymer of any of the clauses 1-4, and/or wherein the composite comprises the synthetic polymer of any of the clauses 15-16 wherein the continuous phase comprises the second phase comprising the poly (HEMA) phase separated from the first phase comprising the copolymer.
25. A window 400 (e.g., smart window), or coating or insertion for a window, comprising (see e.g., FIG. 4):
a first transparent phase changing polymer comprising a plurality of nanocrystallites having a maximum dimension or crystal size (as measured from an X-ray diffraction peak by the Scherrer equation) of 100 nm or less below a threshold 35-42 degrees Celsius;
a plurality of amorphous particles comprising a second polymer combined with the first polymer, wherein the particles have a maximum dimension of 50 nm-10 micrometers, and the first polymer and the second polymer have their refractive indices matched to within 0.01 below the threshold temperature but are mismatched (more than 0.02 difference) above the threshold temperature.
26 The window or coating or insertion of clause 25, comprising the composite, synthetic polymer, or transparent semicrystalline polymer of any of the clauses 1-24.
27. A window (e.g., smart window) comprising, consisting of, or coated or inserted with the composite, the synthetic polymer, or semicrystalline copolymer of any of the the clauses 1-26.
28. A window (e.g., smart window) comprising the synthetic polymer, or composite or film of any of the clauses 5-24, wherein the composite, film the synthetic polymer, the semicrystalline copolymer, the clear liquid, comprise a film that is transparent (over 90% average transmittance for electromagnetic radiation having wavelengths in a range of 380 nm to 2500 nm) at the temperature below 40 degrees Celsius and opaque (less than average 20% transmittance for the wavelengths in a range of 380 nm to 2500 nm) at the temperature above 45 degrees Celsius, with a modulation of at least 80%
where average transmittance is calculated as

$${T}_{s o lar} , {T}_{vis} , {T}_{NIR} = \frac{\int ϕ ( λ ) T ( λ ) d λ}{\int ϕ ( λ ) d λ}$$

and the modulation is calculated as
ΔTₛₒₗₐᵣ, ΔTᵥᵢₛ, ΔT_{NIR}=Tₛₒₗₐᵣ, Tᵥᵢₛ, T_{NIR} (cool state less than 40 degrees Celsius)-Tₛₒₗₐᵣ, Tᵥᵢₛ, T_{NIR} (hot state more than 40 degrees Celsius)

T(λ) represents the recorded transmittance spectrum at a particular wavelength, for T_{solar/NIR}, φ(λ) is the solar irradiance spectrum for air mass 1.5, for Tᵥᵢₛ, φ(λ) is the CIE “physiologically relevant” luminous efficiency function, and the transmittance and modulation stays the same after 1000 cycles between the hot state and the cold state and transmittance is the ratio of the radiant flux Φₜ transmitted to the incident radiant flux.
29. The window, coating, or insertion of any of the clauses 25-28, wherein text is readable through composite, the synthetic polymer, or the coating at 40 degrees Celsius but not readable above 45 degrees, or wherein the composite, the synthetic polymer, or the coating comprises a window for visible wavelengths at 40 degrees Celsius and a tint at higher temperatures.
30. The window of any of the claims 25-29 wherein the window comprising the composite or synthetic polymer is self supporting as a window or is coated on a substrate such as a glass or a glass pane having a transmittance of over 90% for the electromagnetic radiation for all wavelengths in a range of 380 nm to 780 nm.
31. The window of any of the clauses 25-30 enclosed in a chamber to suppress the temperature increase under solar irradiation, so as to tune the temperature at which the window becomes opaque.
32. A method of making a polymer useful as a coating or window or precursor for a smart window, comprising:
solution processing a plurality of monomer precursors with appropriate ratios to form a precursor mixture; and
curing the precursor mixture with ultraviolet radiation to increase a temperature of the mixture to above a threshold temperature to form the polymer of any of the clauses 1-24.
33. The method of clause 32, wherein the threshold temperature is 120 degrees Celsius.
34. The method of any of the clauses 32-33, wherein the precursors comprise the first co-monomer, the second co-monomer and optionally at least one of the third co-monomer, the additive, the non reactive small molecule, or the fourth co-monomer.
35. The method of any of the clauses 32-34, wherein the appropriate ratios are such that the first comonomer forms a polymer that is at least 75% by weight of the copolymer and optionally the third comonomer forms a polymer (e.g., poly (HEMA)) that is at least 30% of the synthetic polymer, or composite, by weight, and further comprising 5-20% of the additive by weight of the second continuous phase.
36. The transparent semi-crystalline copolymer of any of the clauses 1~4 remaining transparent at all temperatures. In one or more embodiments, “elevated temperature” in the embodiments 1~4 for the synthesis of the copolymer and polymer is much higher than the critical or threshold temperature of transparency switching in the polymer. In on or more embodiments, the elevated temperature is above 100 degrees celsius or significantly higher than the threshold temperature in clauses 16-31 at which the smart window transitions from transparent to opaque.
37. A composite 2100 comprising a nanocrystal of the copolymer of any of the clauses combined with refractive index-matched submicron-size amorphous polymer particles 2106 (μPs) to form optically transparent composite films under ambient conditions.
38. A composite film 2100 comprising:
a nanophasic crystalline polymer (NCP) 2104 comprising nanocrystallites 2110 having a crystal size of 100 nm or less (e.g., as measured by the Scherrer equation from X-ray diffraction data);
submicron-size amorphous polymer microparticles (μPs) 2106 dispersed within the NCP, wherein the μPs have a diameter in a range of 50 nm to 10 micrometers; and wherein the NCP and the μPs have refractive indices matched to within 0.01 at a temperature below a threshold temperature in a range of 35-42 degrees Celsius, rendering the composite film optically transparent with greater than 90% average transmittance in a wavelength range of 380 nm to 2500 nm.
39. The composite film of claim 38, wherein above the threshold temperature, the nanocrystallites melt into an amorphous state, creating a refractive index mismatch greater than 0.02 between the NCP and the μPs, causing the composite film to become opaque with less than 20% average transmittance in the wavelength range of 380 nm to 2500 nm.
40. The composite film of claim 38, wherein the NCP comprises a copolymer of a first comonomer selected from the group consisting of stearyl acrylate, hexadecyl acrylate, tetradecyl acrylate, lauryl acrylate, and N-docosyl acrylate, and a second comonomer comprising a crosslinker selected from ethoxylated trimethylolpropane triacrylate or a difunctional acrylate.
41. The composite film of claim 38, wherein the μPs comprise a copolymer of methyl methacrylate and styrene, optionally crosslinked with divinylbenzene or trimethylolpropane trimethacrylate.
42. The composite film of claim 40, wherein the NCP retains at least 50% crystallinity relative to a homopolymer of the first comonomer, and exhibits a transmittance modulation of at least 80% between the transparent state below the threshold temperature and the opaque state above the threshold temperature.
43. A composite film 2100 comprising: the transparent semicrystalline copolymer of any of the clauses 1-36 forming a nanophasic crystalline polymer (NCP) comprising nanocrystallites having a crystal size of 100 nm or less as measured by the Scherrer equation from X-ray diffraction data; submicron-size amorphous polymer microparticles (μPs) dispersed within the NCP, wherein the μPs have a diameter in a range of 50 nm to 10 micrometers; and wherein the NCP and the μPs have refractive indices matched to within 0.01 at a temperature below a threshold temperature in a range of 35-42 degrees Celsius, rendering the composite film optically transparent with greater than 90% average transmittance in a wavelength range of 380 nm to 2500 nm.
44. The composite of claim 43 further comprising the composite of any of the clauses 39-42.
44. A method of making a nanophasic crystalline polymer-microparticle composite film, comprising: synthesizing amorphous polymer microparticles (μPs) having diameters in a range of 50 nm to 10 micrometers via microemulsion polymerization; dispersing the μPs in a mixture of a first comonomer whose homopolymer is semicrystalline and a second comonomer that forms a phase-separated mixture with the first comonomer at ambient temperature; heating the mixture to an elevated temperature above 120 degrees Celsius at which the first and second comonomers form a clear solution; curing the mixture via ultraviolet radiation at the elevated temperature to form a nanophasic crystalline polymer (NCP) with the μPs dispersed therein, wherein nanocrystallites in the NCP have a crystal size of 100 nm or less.
45. The method of claim 44, wherein the μPs are synthesized from a copolymer selected to have a refractive index matching the NCP at a temperature below a threshold temperature in a range of 35-42 degrees Celsius.
46. The method of claim 44, further comprising surface-functionalizing the μPs prior to dispersing by converting hydroxyl groups on the μPs to acrylate or oleic acid ester groups to facilitate dispersion in the comonomer mixture.
47. The method of claim 44, wherein the first comonomer is selected from the group consisting of stearyl acrylate, hexadecyl acrylate, tetradecyl acrylate, and the second comonomer comprises ethoxylated trimethylolpropane triacrylate at a weight ratio of at least 6:1 first comonomer to second comonomer.
48. The method of claim 44, wherein the curing is performed at a temperature in a range of 120-180 degrees Celsius to suppress crystallite domain size to below 100 nm while maintaining at least 50% crystallinity relative to the homopolymer of the first comonomer.
49. The method of claim 44, wherein the curing via ultraviolet radiation is performed at an elevated temperature in a range of 120-180 degrees Celsius, and the ultraviolet curing at the elevated temperature produces phase separation between the first and second comonomers of 15-80 nm in the resulting NCP.

The method of claim 49, wherein increasing the ultraviolet curing temperature within the range of 120-180 degrees Celsius decreases the phase separation size and increases optical transmittance of the resulting composite film at ambient temperature.

A smart window comprising: a transparent substrate; a film coated on or sandwiched within the transparent substrate, wherein the film comprises the transparent semicrystalline copolymer of any of the claims or the composite film of any of the claims; wherein the smart window exhibits greater than 90% average visible transmittance for the solar spectrum at temperatures below 40 degrees Celsius and less than 20% average visible transmittance at temperatures above 45 degrees Celsius, with a solar transmittance modulation of at least 80%.

The smart window of claim 51, wherein the film reduces interior temperature increase by at least 5 degrees Celsius compared to a double-pane glass reference under direct solar radiation when the ambient temperature is above the threshold temperature.

### REFERENCES FOR FIRST EXAMPLE (SECTIONS 1-3)

The following references are incorporated by reference herein.
[1] a) J. W. Lee, H. J. Jung, J. Y. Park, J. B. Lee, Y. Yoon, Renew. Energy 2013, 50, 522; b) E. Cuce, S. B. Riffat, Renew. Sustain. Energy Rev. 2015, 41, 695; c) C. Gehbauer, E. S. Lee, T. Wang, Energy Build. 2023, 298, 113481.
[2] a) M. Arici, H. Karabay, M. Kan, Energy Build. 2015, 86, 394; b) Y. Zhou, F. Fan, Y. Liu, S. Zhao, Q. Xu, S. Wang, D. Luo, Y. Long, Nano Energy 2021, 90, 106613.
[3] a) Y. Ke, C. Zhou, Y. Zhou, S. Wang, S. H. Chan, Y. Long, Adv. Funct. Mater. 2018, 28, 1800113; b) S. K. Kang, D. H. Ho, C. H. Lee, H. S. Lim, J. H. Cho, ACS Appl. Mater. Interfaces 2020, 12, 33838.
[4] Q. Zhang, Y. Jiang, L. Chen, W. Chen, J. Li, Y. Cai, C. Ma, W. Xu, Y. Lu, X. Jia, Z. Bao, Adv. Funct. Mater. 2021, 31, 2100686.
[5] a) G. Cai, A. L.-S. Eh, L. Ji, P. S. Lee, Adv. Sustain. Syst. 2017, 1, 1700074; b) S. Cherumannil Karumuthil, M. K. Ganesha, I. Mondal, A. K. Singh, G. U. Kulkarni, J. Mater. Chem. A 2022, 10, 23265.
[6] J. Li, X. Lu, Y. Zhang, X. Ke, X. Wen, F. Cheng, C. Wei, Y. Li, K. Yao, S. Yang, Adv. Funct. Mater. 2021, 31, 2102350.
[7] a) Y. Ke, J. Chen, G. Lin, S. Wang, Y. Zhou, J. Yin, P. S. Lee, Y. Long, Adv. Energy Mater. 2019, 9, 1902066; b) M. Aburas, V. Soebarto, T. Williamson, R. Liang, H. Ebendorff-Heidepriem, Y. Wu, Appl. Energy 2019, 255, 113522.
[8] a) W. Shen, G. Li, Laser Photonics Rev. 2023, 17, 2200207; b) D. Cupelli, F. Pasquale Nicoletta, S. Manfredi, M. Vivacqua, P. Formoso, G. De Filpo, G. Chidichimo, Sol. Energy Mater. Sol. Cells 2009, 93, 2008.
[9] a) X.-H. Li, C. Liu, S.-P. Feng, N. X. Fang, Joule 2019, 3, 290; b) Y. Zhou, S. Wang, J. Peng, Y. Tan, C. Li, F. Y. C. Boey, Y. Long, Joule 2020, 4, 2458.
[10] a) S. Kiruthika, G. U. Kulkarni, Sol. Energy Mater. Sol. Cells 2017, 163, 231; b) S. Liu, C. Y. Tso, Y. W. Du, L. C. Chao, H. H. Lee, T. C. Ho, M. K. H. Leung, Appl. Energy 2021, 297, 117207.
[11] a) Y.-Q. Feng, M.-L. Lv, M. Yang, W.-X. Ma, G. Zhang, Y.-Z. Yu, Y.-Q. Wu, H.-B. Li, D.-Z. Liu, Y.-S. Yang, Molecules 2022, 27, 1638; b) Y. Xie, F. Guan, Z. Li, Y. Meng, J. Cheng, L. Li, Q. Pei, Macromol. Rapid Commun. 2020, 41, e2000290.
[12] Y. Liu, J. Fan, R. Plamthottam, M. Gao, Z. Peng, Y. Meng, M. He, H. Wu, Y. Wang, T. Liu, C. Zhang, Q. Pei, Chem. Mater. 2021, 33, 7232.
[13] a) V. Prattipati, Y. S. Hu, S. Bandi, S. Mehta, D. A. Schiraldi, A. Hiltner, E. Baer, J. Appl. Polym. Sci. 2006, 99, 225; b) Y. Maruhashi, S. Iida, Polym. Eng. Sci. 2001, 41, 1987.
[14] a) L. Shen, K. Nickmans, J. Severn, C. W. M. Bastiaansen, ACS Appl. Mater. Interfaces 2016, 8, 17549; b) S. A. E. Boyer, J. M. Haudin, Polym. Test. 2010, 29, 445; c) J. Yoon, R. T. Mathers, G. W. Coates, E. L. Thomas, Macromolecules 2006, 39, 1913.
[15] S. Bronnikov, S. Kostromin, V. Zuev, J. Macromol. Sci., Part B 2013, 52, 1718.
[16] a) J. Liu, Y. Yin, K. Wang, P. Wei, H. Lu, C. Song, Q. Liang, W. Huang, iScience 2022, 25, 104090; b) H. Kang, M. A. Uddin, C. Lee, K.-H. Kim, T. L. Nguyen, W. Lee, Y. Li, C. Wang, H. Y. Woo, B. J. Kim, J. Am. Chem. Soc. 2015, 137, 2359; c) Y. Lin, E. Bilotti, C. W. M. Bastiaansen, T. Peijs, Polym. Eng. Sci. 2020, 60, 2351.
[17] D. I. Sagdeev, M. G. Fomina, G. K. Mukhamedzyanov, I. M. Abdulagatov, J. Chem. Thermodyn. 2011, 43, 1824.
[18] a) S. Liu, Y. Li, Y. Wang, Y. Du, K. M. Yu, H.-L. Yip, A. K. Y. Jen, B. Huang, C. Y. Tso, Nat. Commun. 2024, 15, 876; b) Y. Du, S. Liu, Y. Li, X. Chen, T. C. Ho, L. C. Chao, C. Y. Tso, ACS Appl. Mater. Interfaces 2023, 15, 49665; c) Y. Du, S. Liu, Z. Zhou, H. H. Lee, T. C. Ho, S.-P. Feng, C. Y. Tso, Mater. Today Phys. 2022, 23, 100624; d) S. Liu, Y. Li, Y. Wang, K. M. Yu, B. Huang, C. Y. Tso, Adv. Sci. 2022, 9, 2106090.
[19] a) R. Guo, Y. Shen, Y. Chen, C. Cheng, C. Ye, S. Tang, Chem. Eng. J. 2024, 486, 150194; b) L. Xie, X. Wang, X. Zou, Z. Bai, S. Liang, C. Wei, S. Zha, M. Zheng, Y. Zhou, O. Yue, X. Liu, Small 2023, 19, 2304321; c) Y. Feng, W. Ma, H. Li, M. Yang, Y. Yu, S. Liu, X. Zeng, F. Huang, Y. Yang, Z. Li, ACS Appl. Mater. Interfaces 2023, 15, 5836; d) G. Xu, H. Xia, P. Chen, W. She, H. Zhang, J. Ma, Q. Ruan, W. Zhang, Z. Sun, Adv. Funct. Mater. 2022, 32, 2109597.
[20] a) W. Wu, C. Wang, C. Chen, J. Song, F. Ma, Adv. Mater. Interfaces 2023, 10, 2202506; b) J. Kim, K. Haeng Lee, D.-B. Seo, H. Jang, S. Kang, S. Yim, S. Sook Lee, K.-S. An, Chem. Eng. J. 2023, 477, 147014; c) J. Pi, C.-B. Li, R.-Y. Sun, L.-Y. Li, F. Wang, F. Song, J.-M. Wu, X.-L. Wang, Y.-Z. Wang, Compos. Commun. 2022, 32, 101167; d) S. Liu, C. Y. Tso, H. H. Lee, Y. W. Du, K. M. Yu, S.-P. Feng, B. Huang, ACS Appl. Mater. Interfaces 2021, 13, 22495.
[21] a) C. Hong, B. Li, J. Zhang, Y. Li, J. Sun, Adv. Funct. Mater. 2024, 2313781; b) B. Deng, Y. Zhu, X. Wang, J. Zhu, M. Liu, M. Liu, Y. He, C. Zhu, C. Zhang, H. Meng, Adv. Mater. 2023, 35, 2302685; c) J. Zhu, A. Huang, H. Ma, Y. Ma, K. Tong, S. Ji, S. Bao, X. Cao, P. Jin, ACS Appl. Mater. Interfaces 2016, 8, 29742.
[22] T. Ube, J. Imai, M. Yoshida, T. Fujisawa, H. Hasebe, H. Takatsu, T. Ikeda, J. Mater. Chem. C 2022, 10, 12789.
[23] a) T. Palomar, M. Silva, M. Vilarigues, I. Pombo Cardoso, D. Giovannacci, Herit. Sci. 2019, 7, 82; b) Z. Kai, L. YuDai, Z. BaoRong, S. Quan, W. JinBo, W. WeiJia, Front. Mater. 2022, 9.
[24] Further information on one or more embodiments can be found in A Transparent Semicrystalline Polymer Used in Thermally Responsive Smart Window Application” by Jiacheng Fan, Thomas Wakuta, HyeonJi Hong, Ying Liu, Yu-Ching Chen, Rongke Xu, Yuxuan Guo, Jianghan Wu, Isabelle Winardi, Ting-Hsuan Wu, Zhixin Xie, Yuan Meng, Qibing Pei, https://doi.org/10.1002/adfm.202506061 Adv. Funct. Mater. 35, no. 48 (2025): 2506061, and supporting information

### REFERENCES FOR NCP-MICROPARTICLE COMPOSITE IN SECTION 4

The following references are incorporated by reference herein.
H. Kawamoto, The history of liquid-crystal displays. Proceedings of the IEEE 2002, 90, 460-500.
2. A. A. Harraq; Choudhury, B. D.; Bharti, B. Field-induced assembly and propulsion of colloids. Langmuir 2022. 38, 3001-3016.
3. T. Li; Zhai, Y.; He, S.; Gan, W.; Wei, Z.; Heidarinejad, M.; Dalgo, D.; Mi, R.; Zhao, X.; Song, J.; Dai, J.; Chen, C.; Aili, A.; Vellore, A.; Martini, A.; Yang, R.; Srebric, J.; Yin, X.; Hu, L. A radiative cooling structural material. Science 2019, 364, 760-763.
4. X. Zhao; Li, J.; Dong, K.; Wu, J. Switchable and tunable radiative cooling: mechanisms, applications, and perspectives. ACS Nano 2024, 18, 18118-18128.
5. K. Allen; Connelly, K.; Rutherford, P.; Wu, Y. Smart windows—Dynamic control of building energy performance. Energy and Buildings 2017, 139, 535-546.
6. R. Tallberg; Jelle, B. P.; Loonen, R.; Gao, T.; Hamdy, M. Comparison of the energy saving potential of adaptive and controllable smart windows: A state-of-the-art review and simulation studies of thermochromic, photochromic and electrochromic technologies. Solar Energy Materials and Solar Cells 2019, 200, 109828.
7. K. Ryu; Li, G.; Zhang, K.; Guan, J.; Long, Y.; Dong, Z. Thermoresponsive Hydrogels for the Construction of Smart Windows, Sensors, and Actuators. Accounts of Materials Research 2025, 6, 379-392.
8. S. Wang; Jiang, T.; Meng, Y.; Yang, R.; Tan, G.; Long, Y. Scalable thermochromic smart windows with passive radiative cooling regulation. Science 2021, 374, 1501-1504.
9. Y. Xie; Guan, F.; Li, Z.; Meng, Y.; Cheng, J.; Li, L.; Pei, Q. A Phase-changing polymer film for broadband smart window applications. Macromol Rapid Commun 2020, 41, e2000290.
10. H. N. Kim; Yang, S. Responsive smart windows from nanoparticle-polymer composites. Advanced Functional Materials 2019, 30, 1902597.
11. C. Zhang; Yang, J.; Li, Y.; Song, J.; Guo, J.; Fang, Y.; Yang, X.; Yang, Q.; Wang, D.; Deng, X. Vapor-liquid transition-based broadband light modulation for self-adaptive thermal management. Advanced Functional Materials 2022, 32, 2208144.
12. J. Molnár; Sepsi, Ö.; Erdei, G.; Lenk, S.; Ujhelyi, F.; Menyhárd, A. Modeling of light scattering and haze in semicrystalline polymers. Journal of Polymer Science 2020, 58, 1787-1795.
13. S. Tadepalli; Slocik, J. M.; Gupta, M. K.; Naik, R. R.; Singamaneni, S. Bio-Optics and Bio-Inspired Optical Materials. Chemical Reviews 2017, 117, 12705-12763.
14. J. Bauer; Fursenko, O.; Heinrich, F.; Gutke, M.; Kornejew, E.; Broedel, O.; Dietzel, B.; Kaltenbach, A.; Burkhardt, M.; Edling, M.; Steglich, P. Determination of optical constants and scattering properties of transparent polymers for use in optoelectronics. Optical Materials Express 2021, 12, 204-224.
15. C. A. Bunge; Kruglov, R.; Poisel, H. Rayleigh and Mie scattering in polymer optical fibers. Journal of Lightwave Technology 2006, 24, 3137-3146.
16. M. C. Zhang; Guo, B.; Xu, J. A review on polymer crystallization theories, Crystals 2017, 7, 1-17.
17. B. Wunderlich, Reversible crystallization and melting in polymers, J. Macromol. Sci., Part B, 2003, 42, 579-598.
18. A. Pawlak; Krajenta, J. Entanglements of macromolecules and their influence on rheological and mechanical properties of polymers. Molecules 2024, 29, 3410.
19. N. A. Plate; Shibaev, V. P.; Petrukhin, B. S.; Zubov, Y. A.; Kargin, V. A. Structure of crystalline polymers with unbranched long side chains. Journal of Polymer Science Part A-1: Polymer Chemistry, 1971, 9, 2291-2298.
20. K., Inomata; Sakamaki, Y.; Nose, T.; Sasaki, S. Solid-state structure of comb-like polymers having n-octadecyl side chains II. Crystalline-amorphous layered structure. Polymer Journal, 1996, 28, 992-999.
21. Y. Zheng; Bruening, M. L.; Baker, G. L. Crystallization of polymer brushes with poly(ethylene oxide) side chains. Macromolecules, 2007, 40, 8212-8219.
22. H., Sun; Yu, D. M.; Shi, S.; Yuan, Q.; Fujinami, S.; Sun, X.; Wang, D.; Russell, T. P. Configurationally constrained crystallization of brush polymers with poly(ethylene oxide) side chains. Macromolecules, 2019, 52, 592-600.
23. S. Mete; Goswami, K. G.; Ksendzov, E.; Kostjuk, S. V.; De, P. Modulation of side chain crystallinity in alternating copolymers. Polymer Chemistry 2019, 10, 6588-6599.
24. D. Neugebauer; Theis, M.; Pakula, T.; Wegner, G.; Matyjaszewski, K. Densely heterografted brush macromolecules with crystallizable grafts. synthesis and bulk properties. Macromolecules 2006, 39, 584-593.
25. Z. Ren; Hu, W.; Liu, C.; Li, S.; Niu, X.; Pei, Q. Phase-changing bistable electroactive polymer exhibiting sharp rigid-to-rubbery transition. Macromolecules 2016, 49, 134-140.
26. M., Gao; Wu, H.; Plamthottam, R.; Xie, Z.; Liu, Y.; Hu, J.; Wu, S.; Wu, L.; He, X.; Pei, Q. Skin temperature-triggered, debonding-on-demand sticker for a self-powered mechanosensitive communication system. Matter, 2021, 4, 1962-1974.
27. M. Gao; Meng, Y.; Shen, C.; Pei, Q. Stiffness variable polymers comprising phase-changing side-chains: material syntheses and application explorations. Advanced Materials 2022, 34, 2109798.
28. Y. Liu; Fan, J.; Plamthottam, R.; Gao, M.; Peng, Z.; Meng, Y.; He, M.; Wu, H.; Wang, Y.; Liu, T.; Zhang, C.; Pei, Q. Automatically modulated thermoresponsive film based on a phase-changing copolymer. Chemistry of Materials. 2021, 33, 7232-7241.
29. M. Arici; Karabay, H.; Kan, M. Flow and heat transfer in double, triple and quadruple pane windows. Energy and Buildings 2015, 86, 394-402.
30. G. Leftheriotis; Yianoulis, P. Comprehensive Renewable Energy. 2012, 3, 313-355.
31. H. A. Ahemd; Al-Faraj, A. A.; Abdel-Ghany, A. M. Shading greenhouses to improve the microclimate, energy and water saving in hot regions: A review. Scientia Horticulturae 2016, 201, 36-45.
32. A. Badji; Benseddik, A.; Bensaha, H.; Boukhelifa, A.; Hasrane, I. Design, technology, and management of greenhouse: A review. Journal of Cleaner Production 2022, 373, 133753.
33. G. Zhang; Wu, H.; Liu, J.; Liu, Y.; Ding, Y.; Huang, H. A review on switchable building envelopes for low-energy buildings. Renewable and Sustainable Energy Reviews 2024, 202, 114716.
34. Y. Ke; Chen, J.; Lin, G.; Wang, S.; Zhou, Y.; Yin, J.; Lee, P. S.; Long, Y. Smart windows: electro-, thermo-, mechano-, photochromics, and beyond. Advanced Energy Materials 2019, 9, 1902066.
35. N. Nasir; Hong, H.; Rehman, M. A.; Kumar, S.; Seo, Y. Polymer-dispersed liquid-crystal-based switchable glazing fabricated via vacuum glass coupling. RSC Advances 2020, 10, 32225-32231.
36. C. Han; Zhou, L. E.; Ma, H.; Li, C.; Zhang, S.; Cao, H.; Zhang, L.; Yang, H. Fabrication of a controllable anti-peeping device with a laminated structure of microlouver and polymer dispersed liquid crystals film. Liquid Crystals 2019, 46, 2235-2244.
37. Cloud Gel Nearing Market Entry. 1994, https://www.buildinggreen.com/product-review/cloud-gel-nearing-market-entry.
38. T. Mori; Tsubaki, J.; O'Shea, J.-P.; Franks, G. V. Hydrostatic pressure measurement for evaluation of particle dispersion and flocculation in slurries containing temperature responsive polymers. Chemical Engineering Science 2013, 85, 38-45.
39. A. Hemaida; Ghosh, A.; Sundaram, S.; Mallick, T. K. Evaluation of thermal performance for a smart switchable adaptive polymer dispersed liquid crystal (PDLC) glazing. Solar Energy 2020, 195, 185-193.
40. F. Liu; Liu, A.; Tao, W.; Yang, Y. Preparation of UV curable organic/inorganic hybrid coatings-a review. Progress in Organic Coatings 2020, 145, 105685.
41. Y. Lin; Bilotti, E.; Bastiaansen, C. W. M.; Peijs, T. Transparent semi-crystalline polymeric materials and their nanocomposites: A review. Polymer Engineering & Science 2020, 60, 2351-2376.
42. Y. Zhang; Wang, K.; Sun, Y.; Xu, M.; Cheng, Z. Novel biphasically and reversibly transparent phase change material to solve the thermal issues in transparent electronics. ACS Applied Materials & Interfaces 2022, 14, 31245-31256.
43. R. M. Cywar; Rorrer, N. A.; Mayes, H. B.; Maurya, A. K.; Tassone, C. J.; Beckham, G. T.; Chen, E. Y. X. Redesigned hybrid nylons with optical clarity and chemical recyclability. Journal of the American Chemical Society 2022, 144, 5366-5376.
44. Y. Xu; Kraemer, D.; Song, B.; Jiang, Z.; Zhou, J.; Loomis, J.; Wang, J.; Li, M.; Ghasemi, H.; Huang, X.; Li, X.; Chen, G. Nanostructured polymer films with metal-like thermal conductivity. Nature Communications 2019, 10, 1771.
45. J. H. Seinfeld; Pandis, S. N. Atomospheric Chemistry and Physics. 2016, John Wiley and Sons.
46. T. Palomar; Silva, M.; Vilarigues, M.; Pombo Cardoso, I.; Giovannacci, D. Impact of solar radiation and environmental temperature on Art Nouveau glass windows. Heritage Science 2019, 7, 82.
47. Z. Kai; YuDai, L.; BaoRong, Z.; Quan, S.; JinBo, W.; WeiJia, W. Modeling, Simulation and Testing of Atomization Temperature Change Point of Thermochromic Glass for Building Energy Saving. Frontiers in Materials 2022, 9.
48. J.-G. Liu; Ueda, M. High refractive index polymers: fundamental research and practical applications. Journal of Materials Chemistry 2009, 19, 8907-8919.
49. C. M. Hansen Hansen solubility parameters: a user's handbook. 2007, CRC press.
50. H. Jianying; Jiayan, C.; Jiaming, Z.; Yihong, C.; Lizong, D.; Yousi, Z. Some monomer reactivity ratios of styrene and (meth)acrylates in the presence of TEMPO. Journal of Applied Polymer Science 2006, 100, 3531-3535.
51. R. Drezek; Dunn, A.; Richards-Kortum, R. A pulsed finite-difference time-domain (fdtd) method for calculating light scattering from biological cells over broad wavelength ranges. Opt. Express 2000, 6, 147-157.
52. K. Muinonen; Nousiainen, T.; Fast, P.; Lumme, K.; Peltoniemi, J. I. Light scattering by gaussian random particles: ray optics approximation. Journal of Quantitative Spectroscopy and Radiative Transfer 1996, 55, 577-601.
53. C. Larpent; Bernard, E.; Richard, J.; Vaslin, S. Synthesis of functionalized nanoparticles via copolymerization in microemulsions and surface reactions. Reactive and Functional Polymers 1997, 33, 49-59.
54. S. Mishra; Chatterjee, A. Novel synthesis of polymer and copolymer nanoparticles by atomized microemulsion technique and its characterization. Polymers for Advanced Technologies 2011, 22, 1593-1601.
55. M. Okubo; Ito, A.; Mori, H.; Suzuki, T. Preparation of cationic nanoparticles by the particle dissolution method from submicron-sized, styrene-butyl acrylate-dimethylaminoethyl methacrylate terpolymer particles. Colloid and Polymer Science, 2003, 281, 168-172.
56. B. Wunderlich, Reversible crystallization and melting in polymers, Journal of Macromolecular Science, Part B, 2003, 42, 579-598.
57. L. Wang; Yang, Y.; Chen, Y.; Majidi, C.; Iida, F.; Askounis, E.; Pei, Q. Controllable and reversible tuning of material rigidity for robot applications. Materials Today 2018, 21, 563-576.
58. J. Kim; Xie, Z.; Peng, Z.; Hong, H.; Shajari, S.; Guo, Y.; Wu, H.; Meng, Y.; Plamthottam, R.; Zhu, Y.; Qiu, Y.; Pei, Q. Deformable joule heating electrode based on hybrid layers of silver nanowires and carbon nanotubes and its application in a refreshable multi-cell braille display. Advanced Functional Materials 2024, 34, 2400023.
59. Z. Wang; Wang, N.; Wang, D.; Tang, Z.; Yu, K.; Wei, W. Method for refractive index measurement of nanoparticles. Opt. Lett. 2014, 39, 4251-4254.
60. K. Youssef; Li, Y.; O'Keeffe, S.; Li, L.; Pei, Q. Fundamentals of materials selection for light-emitting electrochemical cells. Advanced Functional Materials 2020, 30.
61. M. Abubekerov; Wei, J.; Swartz, K. R.; Xie, Z.; Pei, Q.; Diaconescu, P. L. Preparation of multiblock copolymers via step-wise addition of l-lactide and trimethylene carbonate. Chemical Science 2018, 9, 2168-2178.
62. D. Chen; Pei, Q. Electronic Muscles and Skins: A Review of Soft Sensors and Actuators. Chemical Reviews 2017, 117, 11239-11268.
63. J. Liang; Tong, K.; Sun, H.; Pei, Q. Intrinsically stretchable field-effect transistors. MRS Bulletin 2017, 42, 131-137.
64. Y. Qiu; Askounis, E.; Guan, F.; Peng, Z.; Xiao, W.; Pei, Q. Dual-stimuli-responsive polymer composite with ultrawide tunable stiffness range triggered by water and temperature. ACS Applied Polymer Materials 2020, 2, 2008-2015.
65. F. Guan; Xie, Y.; Wu, H.; Meng, Y.; Shi, Y.; Gao, M.; Zhang, Z.; Chen, S.; Chen, Y.; Wang, H.; Pei, Q. Silver nanowire-bacterial cellulose composite fiber-based sensor for highly sensitive detection of pressure and proximity. ACS Nano 2020, 14, 15428-15439.
66. R. Ma; Chou, S.-Y.; Xie, Y.; Pei, Q. Morphological/nanostructural control toward intrinsically stretchable organic electronics. Chemical Society Reviews 2019, 48, 1741-1786.
67. Y. Qiu; Zhang, E.; Plamthottam, R.; Pei, Q. Dielectric elastomer artificial muscle: materials innovations and device explorations. Accounts of Chemical Research 2019, 52, 316-325.

### CONCLUSION

This concludes the description of the preferred embodiment of the present invention. The foregoing description of one or more embodiments of the invention has been presented for the purposes of illustration and description. It is not intended to be exhaustive or to limit the invention to the precise form disclosed. Many modifications and variations are possible in light of the above teaching. It is intended that the scope of the invention be limited not by this detailed description, but rather by the claims appended hereto.

What is claimed is:

1: A transparent semicrystalline copolymer, composed or or comprising of at least:
first repeat units polymerized from a first comonomer whose homopolymer is semicrystalline; and
second repeat units polymerized from a second comonomer which forms a phase separated mixture with the first polymer at a low temperature and the mixture turns transparent at an elevated temperature;
and the copolymer retains no less than 25 percentage of crystallinity relative to the homopolymer of the first comonomer.

2: The transparent semicrystalline copolymer of claim 1, wherein the first comonomer is selected from the group consisting of stearyl acrylate, hexadecyl acrylate, tetradecyl acrylate, lauryl acrylate, N-docosyl acrylate, and the second comonomer is ethoxylated trimethylolpropane triacrylate.

3: The transparent semicrystalline copolymer of claim 1, wherein the first and the second co-monomers are copolymerized at an elevated temperature at which the two comonomers form a clear solution.

4. A synthetic polymer comprising the transparent semicrystalline copolymer of claim 1, further comprising a third polymer polymerized from at least a third comonomer which is phase separated from the clear liquid solution of the first and second comonomers at the elevated temperature.

5. The synthetic polymer of claim 4 polymerized from the phase and the clear liquid solution, wherein:
a first additive is dissolved in the phase formed by the third comonomer to adjust its refractive index; and/or
a second additive is dissolved in the clear liquid solution of the first and second comonomers to adjust the refractive index of the clear liquid solution.

6. The synthetic polymer of claim 5 wherein the additive is diethylene glycol.

7. The synthetic polymer of claim 4 wherein the third comonomer is hydroxyethyl methacrylate.

8. The synthetic polymer of claim 7, comprising:
a first phase comprising the copolymer comprising poly(stearyl acrylate), poly(hexadecyl acrylate), poly(tetradecyl acrylate), poly(lauryl acrylate), or poly(N-docosyl acrylate) main chains crosslinked with ethoxylated trimethylolpropane triacrylate; and
a second phase comprising poly(hydroxyethyl methacrylate) (poly (HEMA)) phase separated from the first phase,
wherein the poly(SA) is at least 75% by weight of the copolymer and the poly (HEMA) is at least 30% of the synthetic polymer by weight.

9. The synthetic polymer of claim 8, wherein the copolymer further comprises one or more alkyl side chains (N—CₙH₂ₙ₊₁ where n is 12 or larger) connected to a main chain.

10. The synthetic polymer of claim 8 further comprising 5-20% of an additive, for adjusting refractive index, by weight of the second phase.

11. The synthetic polymer of claim 8, wherein the copolymer:
crystallizes to form nanocrystallites each having a maximum dimension less than 100 nm at a temperature below a threshold temperature in a range of 35-42 degrees Celsius, wherein the synthetic polymer is transparent; and
above the threshold temperature, the nanocrytsallites melt by undergoing a glass transition into an amorphous state so that solar electromagnetic radiation, having wavelengths in a range of 300 nm-2500 nm, scatters from phase boundaries between the separated phases ot render the synthetic polymer opaque.

12. A composite, comprising:
a first phase comprising a polymer; and
a second phase phase comprising a copolymer phase separated from the first phase; and
wherein the first phase and the second phase have a matching refractive index below a threshold temperature but not above the threshold temperature.

13. The composite of claim 12, comprising:
the copolymer comprises poly(stearyl acrylate), poly(hexadecyl acrylate), poly(tetradecyl acrylate), poly(lauryl acrylate), or poly(N-docosyl acrylate) main chains crosslinked with ethoxylated trimethylolpropane triacrylate; and
a polymer comprises poly(hydroxyethyl methacrylate) (poly (HEMA)).

14. The composite of claim 12, wherein:
the second phase comprises particles dispersed in the first phase comprising a continuous phase or matrix or
the first phase comprises microparticles dispersed in the second phase comprising a matrix.

15. The composite of claim 14, wherein the copolymer comprises a plurality of nanocrystallites having a maximum dimension or crystal size of 100 nm or less below a threshold temperature 35-42 degrees Celsius, and wherein above the threshold transition temperature the particles are amorphous.

16. The composite of claim 12, wherein the copolymer comprises a polyacrylate with sidechains that crystallize into nanoscale domains below a threshold temperature.

17. A window, or coating or insertion for a window comprising the composite of claim 12.

18. A method of making a composite useful as a coating or insertion for a smart window, comprising:
combining a plurality of monomer precursors with a separate phase and a photoinitiator to form a mixture;
heating the mixture to an elevated temperature above 120 degrees Celsius; and exposing the heated precursor mixture to ultraviolet radiation to initiate polymerization reactions via the photoinitiator, forming a composite comprising a first phase comprising a copolymer and a second phase comprising a polymer phase separated from the first phase; wherein the first phase and the second phase have matching refractive indices below a threshold temperature of 35-42 degrees Celsius but mismatched refractive indices above the threshold temperature.

19. The method of claim 18, wherein the precursors comprise a first comonomer (e.g., SA) and a second comonomer (e.g., crosslinker e.g., ETPTA) and the separate phase comprises a third comonomer (e.g., HEMA), the method further comprising: forming a clear liquid solution of the first comonomer and the second comonomer at the elevated temperature, wherein the third comonomer is phase separated from the clear liquid solution; and wherein the ultraviolet radiation initiates copolymerization of the first comonomer and the second comonomer to form the copolymer and polymerization of the third comonomer to form the polymer, wherein the copolymer is dispersed as particles in the polymer comprising a continuous phase.

20. The method of claim 18, further comprising: dispersing pre-formed amorphous polymer microparticles having a size of 50 nm to 10 micrometers to form the separate phase in the mixture prior to heating; wherein the monomer precursors comprise a first comonomer (e.g., SA) and a second comonomer (e.g., crosslinker, e.g., ETPTA) that form a clear solution at the elevated temperature; and wherein the ultraviolet radiation initiates copolymerization of the first comonomer and the second comonomer to form a nanophasic crystalline polymer forming a continuous phase with the microparticles dispersed therein.
